(19) United States
(12) Patent Application Publication
(10) Pub. No.: US 2012/0009492 A1
(43) Pub. Date: Jan. 12, 2012

(54) FUEL CELL SYSTEM, CONTROL METHOD FOR THE FUEL CELL SYSTEM, AND STATE DETECTION METHOD FOR FUEL CELL

(75) Inventor: Takatoshi Masui, Mishima-shi (JP)

(73) Assignee: TOYOTA JIDOSHA KABUSHIKI KAISHA, Toyota-shi (JP)

(21) Appl. No.: 13/255,414

(22) PCT Filed: Mar. 8, 2010
(86) PCT No.: PCT/IB2010/000732

§ 371 Date: Sep. 8, 2011

(30) Foreign Application Priority Data
Mar. 9, 2009 (JP) 2009-054891
Mar. 24, 2009 (JP) 2009-072916

(51) Int. Cl. H01M 8/04; H01M 8/06

(52) U.S. Cl. 429/423; 429/444; 429/431

(57) ABSTRACT

A fuel cell system includes a fuel cell, a fuel supply portion that supplies fuel to the fuel cell, a combustion portion that burns an anode exhaust gas discharged from the anode of the fuel cell, and an oxygen concentration detection portion that detects the oxygen concentration in a predetermined gas. The fuel flow control portion controls the amount of flow of fuel supplied from the fuel supply portion to the fuel cell so that the amount of fluctuation of the oxygen concentration in the combustion exhaust gas discharged from the combustion portion which is detected by the oxygen concentration detection portion is between a first value and a second value that is larger than the first value.

### BACKGROUND OF THE INVENTION

1. Field of the Invention

The invention relates to a fuel cell system, and a control method for the fuel cell system, and also relates to a state detection method for a fuel cell.

2. Description of the Related Art

A fuel cell is generally a device that acquires electric energy using hydrogen and oxygen as fuel. Since the fuel cell is excellent for environmental protection and is able to achieve high energy efficiency, the study and development of the fuel cell as a future energy supply system has been widely conducted.

To supply hydrogen as a fuel to a fuel cell that generates electricity by the electrochemical reaction between hydrogen and oxygen, there are generally two methods: one is to supply hydrogen stored in a high-pressure tank or the like; and the other is to supply hydrogen obtained by reforming a fuel that contains hydrogen atoms. In the case where the latter method is employed, hydrogen is produced by, for example, supplying a reformation fuel (alcohol or the like, such as methanol, ethanol, etc., hydrocarbon, such as gasoline, natural gas, propane, etc., aldehyde, ammonia, etc.) to a reformer together with water and oxygen (air), and heating the reformation fuel, water and oxygen. A related technology in which the amount of flow of fuel supplied to a fuel cell is calculated on the basis of changes in the electric current generated or changes in the generated voltage is disclosed in Japanese Patent Application Publication No. 2005-44708 (JP-A-2005-44708), Japanese Patent Application Publication No. 2005-93218 (JP-A-2005-93218) and Japanese Patent Application Publication No. 11-40178 (JP-A-11-40178).

A fuel cell system that includes a fuel cell, and a combustion portion that burns an anode exhaust gas that is discharged from the anode of the fuel cell has been proposed. Combustion heat generated in this fuel cell system is utilized, for example, for heating water, or for producing hydrogen by the foregoing reformer.

With the foregoing method in which the amount of flow of fuel supplied to the fuel cell is calculated on the basis of changes in the generated current or the generated voltage, there is possibility that the fuel cell system equipped with a combustor may fail to appropriately control the fuel flow amount.

Besides, some fuel cell systems equipped with a fuel cell are equipped with a reformer for producing hydrogen from a fuel such as hydrocarbon or the like. The foregoing problem is also present with the technology disclosed in International Publication No. 20005/018035 in which degradation of the reformer is detected by detecting the hydrocarbon concentration in the fuel gas produced by the reformer.

### SUMMARY OF THE INVENTION

The invention provides a fuel cell system that has a fuel cell and a combustion portion and that is capable of properly controlling the amount of flow of fuel, and a control method for the fuel cell system. The invention also provides a fuel cell system capable of detecting the state of a fuel cell without a need to provide a hydrocarbon sensor, and a state detection method for a fuel cell.

A first aspect of the invention relates to a fuel cell system that includes: a fuel cell; a fuel supply portion that supplies a fuel to the fuel cell; a combustion portion that burns an anode exhaust gas that is discharged from an anode of the fuel cell; an oxygen concentration detection portion that detects oxygen concentration; and a fuel flow control portion that controls amount of flow of the fuel supplied from the fuel supply portion to the fuel cell so that amount of fluctuation of the oxygen concentration in a combustion exhaust gas discharged from the combustion portion which is detected by the oxygen concentration detection portion is between a first value and a second value that is larger than the first value.

It is considered that the fluctuation of the oxygen concentration in the combustion exhaust gas is great if the combustion in the combustion portion is not good (e.g., if misfire occurs in a portion of the combustion portion). This occurs due to decreases of the air excess rate in the whole combustion portion or a part of the combustion portion which occur in association with an electricity generation failure of the whole fuel cell or one or more of the unit cells of the fuel cell, that is, in association with decreases of the fuel utilization rate in the one or more unit cells. Whether or not a unit cell comes to have electricity generation failure is affected also by the amount of flow of fuel to the unit cell. According to the foregoing construction, the amount of flow of fuel supplied to the fuel cell can be adjusted so that the fluctuation of the oxygen concentration in the combustion exhaust gas is in an appropriate range, and therefore the unit cells with the electricity generation failure can be brought toward a good state of electricity generation. That is, a proper control of the fuel flow amount can be performed so that the stability of electricity generation of the fuel cell improves. As another cause of increasing the fluctuation of the oxygen concentration in the combustion gas, it is possible to conceive a change that occurs in the air excess rate set for stable combustion due to degradation of the combustion portion itself, or the like. In this case, too, if the amount of flow of fuel supplied to the fuel cell is adjusted, an appropriate air excess rate that stabilizes the combustion in the combustion portion can be achieved.

In the fuel cell system in accordance with the invention, the fuel flow control portion may increase the amount of flow of the fuel if the amount of fluctuation of the oxygen concentration in the combustion exhaust gas is larger than the second value, and the flow control portion may decrease the amount of flow of the fuel if the amount of fluctuation of the oxygen concentration in the combustion exhaust gas is smaller than the first value.

In the case where the oscillation amplitude of the oxygen concentration in the combustion exhaust gas is larger than the second value, it is considered that the electricity generation failure has occurred in the fuel cell. According to the foregoing construction, in that case, the state of electricity generation in the fuel cell is improved by increasing the amount of flow of fuel. On the other hand, in the case where the oscillation amplitude of the oxygen concentration in the combustion exhaust gas is smaller than the first value, the state of electricity generation of the fuel cell is considered to be good, but there is possibility of excess supply of fuel. Therefore, in that case, by decreasing the amount of flow of fuel, the stability of electricity generation can be improved, and the electricity generation efficiency can be also improved.

In the fuel cell system in accordance with this aspect, the fuel supply portion may include a fuel production portion that produces the fuel that is supplied to the fuel cell, by using combustion heat generated by the combustion portion, and a raw-material supply portion that supplies the fuel production portion with a raw material for use for the production of the fuel. The fuel flow control portion may control the fuel flow amount supplied to the fuel cell by controlling the amount of flow of the raw material that is supplied to the fuel production portion.

According to the foregoing construction, the stability of electricity generation is improved in the fuel cell system that is equipped with a fuel production portion.

In the fuel cell system in accordance with this aspect, the first value and the second value may be determined based on the amount of fluctuation of the oxygen concentration in air which is detected by the oxygen concentration detection portion.

According to the foregoing construction, the first value and the second value can be set according to time-dependent changes of the oxygen concentration detection portion.

In the fuel cell system in accordance with this aspect, the smaller absolute value of the oxygen concentration in the combustion exhaust gas may be, the wider a range defined by the first value and the second value may be set.

In the case where the absolute value of the oxygen concentration is small, the measurement accuracy of the amplitude declines. According to the foregoing construction, however, even in this case, malfunction of the fuel cell system can be restrained.

In the fuel cell system in accordance with this aspect, the smaller the absolute value of the oxygen concentration in the combustion exhaust gas may be, the more the fuel flow control portion may reduce proportion of increase/decrease of the amount of flow of the fuel, when controlling the amount of flow of the fuel so that the amount of fluctuation of the oxygen concentration in the combustion exhaust gas is between the first value and the second value.

As stated above, in the case where the absolute value of the oxygen concentration is small, the measurement accuracy of the amplitude declines. According to the foregoing construction, however, even in this case, malfunction can be restrained.

The fuel cell system in accordance with this aspect may further include at least one of an ammeter that measures output current of the fuel cell and a voltmeter that measures output voltage of the fuel cell, and the fuel flow control portion may control the amount of flow of the fuel so that oscillation amplitude of one of the output current measured by the ammeter and the output voltage measured by the voltmeter is between a third value and a fourth value that is larger than the third value. According to this construction, the stability of electricity generation further improves.

In the fuel cell system in accordance with this aspect, the fuel flow control portion may increase the amount of flow of the fuel if the oscillation amplitude of one of the output current measured by the ammeter and the output voltage measured by the voltmeter is larger than the fourth value, and the fuel flow control portion may decrease the amount of flow of the fuel if the oscillation amplitude of one of the output current measured by the ammeter and the output voltage measured by the voltmeter is smaller than the third value.

In the case where the oscillation amplitude of the output current of the fuel cell is larger than the fourth value, it is considered that the fuel cell has electricity generation failure. According to the foregoing construction, in that case, the state of electricity generation of the fuel cell is improved by increasing the amount of flow of fuel. On the other hand, in the case where the oscillation amplitude of the output current of the fuel cell is smaller than the third value, the state of electricity generation of the fuel cell is considered to be good, but there is possibility of excess supply of fuel. Therefore, in that case, by decreasing theamount of flow of fuel, the stability of electricity generation can be improved, and the electricity generation efficiency can be also improved.

In the fuel cell system in accordance with this aspect, the smaller the absolute value of the output current may be, the wider the range defined by the third value and the fourth value may be set.

In the case where electric current whose absolute value is small is to be measured, the measurement accuracy of the amplitude declines. According to the foregoing construction, malfunction can be restrained by setting the range defined by the third value and the fourth value wider the smaller the absolute value of the output current is.

In the fuel cell system in accordance with this aspect, the smaller the absolute value of the output current may be, the more the fuel flow control portion may reduce the proportion of increase/decrease of the amount of flow of the fuel, when controlling the amount of flow of the fuel so that the oscillation amplitude of the output current is between the third value and the fourth value.

As stated above, in the case where electric current whose absolute value is small is to be measured, the measurement accuracy of the amplitude declines. According to the foregoing construction, malfunction can be restrained by making the proportion of increase/decrease of the amount of flow of fuel smaller the smaller the absolute value of the output current is.

In the fuel cell system in accordance with this aspect, the amount of fluctuation of the oxygen concentration in the exhaust gas may be an oscillation amplitude of the oxygen concentration.

The fuel cell system in accordance with this aspect may further include: a reformation portion that produces hydrogen from a hydrocarbon; a determination portion that determines whether the fuel cell has degraded based on an amount of fluctuation of the oxygen concentration in the exhaust gas from the combustion portion that is the predetermined gas which is detected by the oxygen concentration detection portion; and wherein the fuel cell generates electricity by using, as a fuel, hydrogen produced by the reformation portion.

According to the foregoing construction, the state of the fuel cell can be detected without a need to provide hydrocarbon sensor.

The fuel cell system in accordance with this aspect may further include air excess rate control means for controlling an air excess rate in the combustion portion, and the air excess rate control means may increase the air excess rate when the determination portion acquires the amount of fluctuation of the oxygen concentration in the exhaust gas. According to this construction, the fluctuation of the oxygen concentration becomes larger with increases in the air excess rate. Therefore, the detection accuracy of the oxygen concentration fluctuation improves.

In the fuel cell system in accordance with this aspect, the larger the amount of fluctuation of the oxygen concentration in the exhaust gas relative to increase of the air excess rate in the combustion portion may be, the larger the determination portion determines that degradation of the fuel cell may be. According to this construction, the degradation of the fuel cell can be quantitatively determined.

The fuel cell system in accordance with this aspect may further include a notification device that notifies a user of degradation of the fuel cell if the determination portion determines that the fuel cell has degraded. Besides, in the fuel cell system in accordance with this aspect, the amount of fluctuation of the oxygen concentration may be a standard deviation that is calculated from a plurality of detection values that are detected by the oxygen sensor during a predetermined period, and the fuel cell may be a solid oxide type fuel cell, and the anode of the fuel cell may contain nickel.

A second aspect of the invention relates to a state detection method for a fuel cell which includes a reformation portion that produces hydrogen from a hydrocarbon and a combustion portion that burns an anode off-gas, and which generates electricity by using, as a fuel, the hydrogen produced by the reformation portion. This state detection method includes detecting oxygen concentration in an exhaust gas from the combustion chamber, and determining presence/absence of a degradation of the fuel cell based on an amount of fluctuation of the oxygen concentration in the exhaust gas detected.

According to the foregoing construction, the state of the fuel cell can be detected without a need to provide a hydrocarbon sensor.

In the state detection method in accordance with this aspect, determining presence/absence of a degradation of the fuel cell may include increasing air excess rate in the combustion portion in order to acquire the amount of fluctuation of the oxygen concentration in the exhaust gas. According to this construction, the fluctuation of the oxygen concentration becomes larger with increases in the air excess rate. Therefore, the detection accuracy of the oxygen concentration fluctuation improves.

In the state detection method in accordance with this aspect, determining presence/absence of a degradation of the fuel cell may include determining a level of the degradation of the fuel cell, and the larger the amount of fluctuation of the oxygen concentration in the exhaust gas relative to the increase in the air excess rate in the combustion portion may be, the larger the determined level may be. According to this construction, the degradation of the fuel cell can be quantitatively determined.

The state detection method in accordance with this aspect may further include notifying a user of the degradation of the fuel cell if it is determined that the fuel cell has degraded. Besides, in the state detection method in accordance with this aspect, the amount of fluctuation of the oxygen concentration may be a standard deviation that is calculated from a plurality of detection values that are detected during a predetermined period, and the fuel cell may be a solid oxide type fuel cell, and an anode of the fuel cell may contain nickel.

A third aspect of the invention relates to a control method for a fuel cell system that includes a fuel cell and a combustion portion that burns ann anode exhaust gas that is discharged from an anode of the fuel cell. This control method includes acquiring an oxygen concentration in a combustion exhaust gas that is discharged from the combustion portion, and controlling amount of flow of a fuel supplied to the fuel cell so that amount of fluctuation of the oxygen concentration in the combustion exhaust gas acquired is between a first value and a second value that is larger than the first value.

In the control method in accordance with this aspect, the amount of fluctuation of the oxygen concentration in the exhaust gas may be an oscillation amplitude of the oxygen concentration.

A fourth aspect of the invention relates to a fuel cell system that includes: a reformation portion that produces hydrogen from a hydrocarbon; a fuel cell that generates electricity by using, as a fuel, hydrogen produced by the reformation portion; a combustion portion that burns an anode exhaust gas that is discharged from an anode of the fuel cell; an oxygen concentration detection portion that detects oxygen concentration in the anode exhaust gas; and a determination portion that determines whether the fuel cell has degraded based on an amount of fluctuation of the oxygen concentration in the exhaust gas from the combustion portion which is detected by the oxygen concentration detection portion.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is an illustrative diagram schematically showing a construction of a fuel cell system as a first embodiment of the invention;

FIG. 2 is a flowchart representing a sensor warm-up detection routine in the first embodiment;

FIG. 3 is a flowchart representing a fuel flow calculation routine in the first embodiment;

FIG. 4 is a diagram showing a relation between the oxygen concentration fluctuation value and a correction coefficient in the first embodiment;

FIG. 5 is a diagram showing a relation between the load demand and the basic fuel flow amount in the first embodiment;

FIG. 6 is an illustrative diagram schematically showing a construction of a fuel cell system as a second embodiment of the invention;

FIG. 7 is a flowchart representing a fuel flow calculation routine in the second embodiment;

FIG. 8 is a flowchart representing a fuel flow calculation routine in the second embodiment;

FIG. 9 is a diagram showing a relation between a corrected oxygen concentration fluctuation value and a correction coefficient in the second embodiment;

FIG. 10 is a diagram showing a relation between load demand and a basic fuel flow amount in the second embodiment;

FIG. 11 is an illustrative diagram schematically showing a construction of a fuel cell system as a third embodiment of the invention;

FIG. 12 is a flowchart representing a portion of a fuel flow calculation routine in the third embodiment;

FIG. 13 is a diagram showing a relation between the output current fluctuation value and a correction coefficient in the third embodiment;

FIG. 14 is a diagram showing a relation between the oxygen concentration fluctuation value and a correction coefficient in a modification;

FIG. 15 is a schematic diagram showing an overall construction of a fuel cell system in accordance with a fourth embodiment of the invention;

FIG. 16 is a schematic sectional view for minutely describing an oxygen sensor;

FIG. 17 is a schematic diagram for describing details of a fuel cell; and

FIG. 18A is a flowchart showing an example of a flow of process that is executed to acquire an oxygen concentration fluctuation, and FIG. 18B is a flowchart showing an example of a flow of process that is executed when the presence/absence of degradation of the fuel cell is determined using the oxygen concentration fluctuation that is stored in the process shown by the flowchart of FIG. 18A.

### DETAILED DESCRIPTION OF EMBODIMENTS

Embodiments of the invention will now be described below.

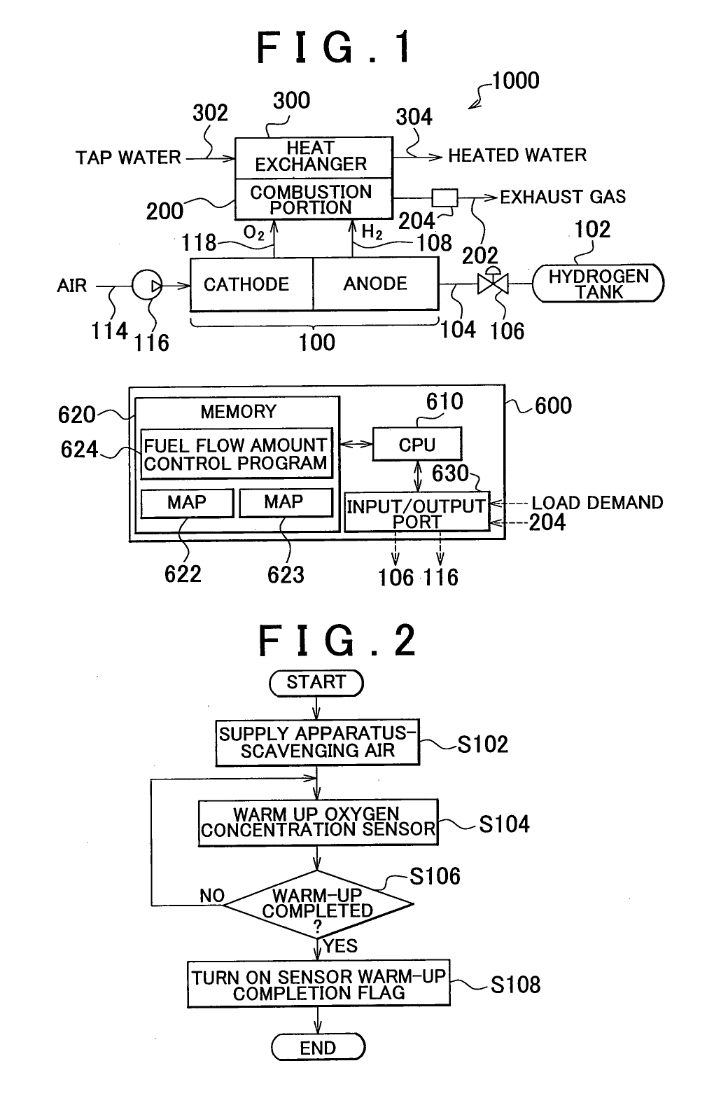

FIG. 1 is an -illustrative diagram schematically showing a construction of a fuel cell system 1000 as a first embodiment of the invention. The fuel cell system 1000 mainly includes a fuel cell stack 100, a combustion portion 200, a heat exchanger 300 and a control portion 600.

The fuel cell system 1000 of this embodiment, using an anode exhaust gas and a cathode exhaust gas that are discharged from the fuel cell stack 100, causes the combustion of the anode exhaust gas in the combustion portion 200, and uses heat produced in the combustion portion 200 to heat tap water via the heat exchanger 300, and supplies heated water to users.

The fuel cell stack 100 obtains electromotive force since hydrogen as a fuel gas and oxygen in the air as an oxidant gas undergo electrochemical reaction. In this embodiment, the fuel cell stack 100 is a solid oxide fuel cell (SOFC) whose reaction temperature is about 600 to 1000° C.

A hydrogen supply system that supplies hydrogen as a fuel gas to the fuel cell stack 100 includes a hydrogen tank 102, a hydrogen supply passageway 104, and a flow-regulating valve 106 that is provided in the hydrogen supply passageway 104. In this embodiment, the hydrogen tank 102 is a hydrogen cylinder that stores high-pressure hydrogen. Instead of the hydrogen tank 102, a tank that has therein a hydrogen storage alloy and stores hydrogen by the storage thereof into the hydrogen storage alloy may also be used.

The hydrogen gas stored in the hydrogen tank 102 is adjusted to a predetermined amount of flow by the flow-regulating valve 106, and is supplied as a fuel gas to the anode of each of unit cells that constitute the fuel cell stack 100. As described below, the flow-regulating valve 106 is controlled on the basis of fluctuation of the concentration of oxygen in a combustion exhaust gas that is discharged from the combustion portion 200 (hereinafter, the term fluctuation refers to the amount of fluctuation, and refers to the oscillation amplitude in the case where the oxygen concentration oscillates).

The exhaust gas discharged from the anode side of the fuel cell stack 100 (which hereinafter is referred to as “anode exhaust gas”) is supplied to the combustion portion 200 via an anode exhaust gas passageway 108.

An air supply system that supplies air as an oxidant gas to the fuel cell stack 100 includes an air supply passageway 114, and an air pump 116 that is provided on the air supply passageway 114. The air pump 116 takes in air from the outside via an air cleaner (not shown) and supplies the air as an oxidant gas to the cathodes of the fuel cell stack 100 via the air supply passageway 114.

The exhaust gas discharged from the cathode side of the fuel cell stack 100 (which hereinafter is also referred to as “cathode exhaust gas”) is supplied to the combustion portion 200 via the cathode exhaust gas passageway 118.

Besides, the fuel cell stack 100 has therein a cooling water channel through which cooling water circulates (not shown). Because the cooling water circulates between the cooling water channel that is formed within the fuel cell stack 100 and a radiator (not shown), the internal temperature of the fuel cell stack 100 is kept in a predetermined temperature range.

The combustion portion 200 is equipped with a glow ignition mechanism. By applying a predetermined voltage to the glow ignition mechanism, combustion is caused between the anode exhaust gas supplied thereto via the anode exhaust gas passageway 108 and the cathode exhaust gas supplied thereto via the cathode exhaust gas passageway 118.

The combustion portion 200 is provided with a combustion exhaust gas passageway 202 via which a combustion exhaust gas containing a burnt gas produced in the combustion portion 200 and an unburnt gas is released into the atmosphere.

An oxygen concentration sensor 204 is provided in the combustion exhaust gas passageway 202. The oxygen concentration sensor 204 detects the oxygen concentration in the combustion exhaust gas, and outputs the detected oxygen concentration to the control portion 600.

The heat exchanger 300 is provided with a tap water introduction passageway 302 and a heated water release passageway 304. In the heat exchanger 300, the tap water introduced via. The tap water introduction passageway 302 is heated by combustion heat produced by the combustion in the combustion portion 200, and thus becomes heated water.

The heated water release passageway 304 is connected to a water storage tank (not shown). The heated water that is heated by the heat exchanger 300 is stored into a water storage tank via the heated water release passageway 304. The water storage tank is connected to a bath, a shower, etc. of a user's house, and heated water is supplied from the water storage tank to the user according to a request from the user. Incidentally, the heated water in the water storage tank may also be introduced into the heat exchanger 300 again so as to be re-heated. This is suitable, for example, in the case where the temperature of the heated water in the water storage tank drops, or where the temperature thereof is lower than the temperature requested by the user, etc.

The control portion 600 is constructed as a logic circuit that has a microcomputer as a central component. The control portion 600 includes a CPU 610 that executes predetermined computations and the like according to pre-set control programs, a memory 620 that stores a fuel flow control program 624, a map 622, a Map 623, etc., an input/output port 630 that inputs/outputs various signals, etc. The fuel flow control program 624 includes a sensor warm-up detection routine and a fuel flow calculation routine that will be described below.

The control portion 600 acquires the detection signal from the foregoing oxygen concentration sensor 204, information about the load demand to the fuel cell stack 100, etc. Then, on the basis of the acquired information, the control portion 600 calculates an appropriate amount of flow of hydrogen that is supplied to the fuel cell stack 100, and outputs a drive signal to the flow-regulating valve 106 that regulates the amount of flow of hydrogen supplied from the hydrogen tank 102. Besides, the control portion 600 also outputs drive signals to various portions, such as the air pump 116 and the like, which are related to the electricity generation of the fuel cell stack 100.

FIG. 2 is a flowchart representing the sensor warm-up detection routine that is executed by the CPU 610 of the control portion 600 that is provided in the fuel cell system 1000. This routine is executed when the fuel cell system 1000 is started.

When this routine is started as the fuel cell system 1000 is started, the CPU 610 controls the air pump 116 so as to supply air, and thereby starts a process of scavenging the fuel cell system 1000 (step S102). Subsequently, the CPU 610 starts the warm-up of the oxygen concentration sensor 204 (step S104). Then, the CPU 610 determines whether or not the warm-up of the oxygen concentration sensor 204 has been completed (step S106). If the warm-up has not been completed (NO in step S106), the CPU 610 continues the warm-up of the oxygen concentration sensor 204 (step S104). That is, the warm-up of the oxygen concentration sensor 204 is continued until the CPU 610 determines that the warm-up of the oxygen concentration sensor 204 has been completed. When the CPU 610 determines that the warm-up of the oxygen concentration sensor 204 has been completed (YES in step S106), the CPU 610 turns on a sensor warm-up completion flag that is recorded in the memory 620 (step S108), and then ends this routine.

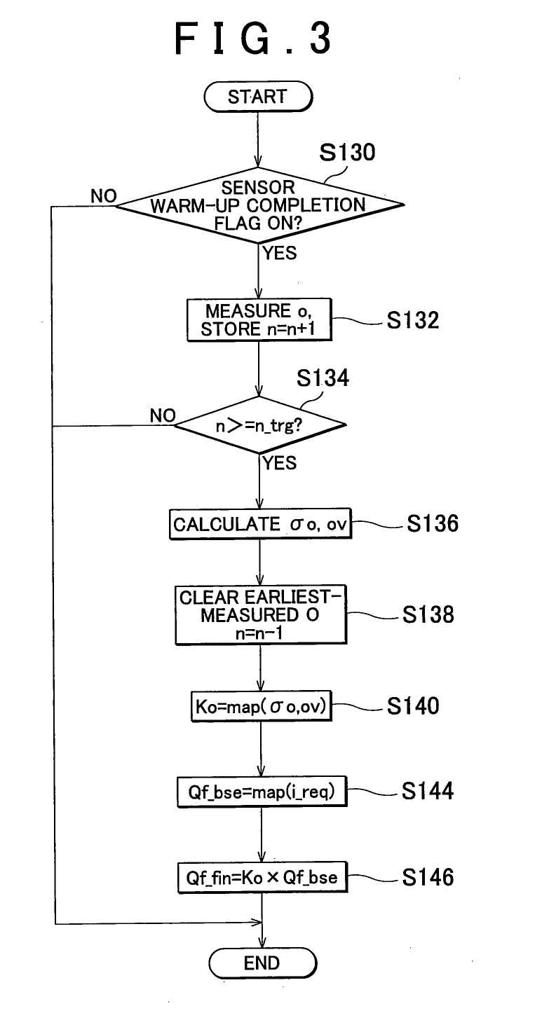

FIG. 3 is a flowchart representing the fuel flow calculation routine that is executed by the CPU 610 of the control portion 600 that is provided in the fuel cell system 1000. This routine is executed when the fuel cell system 1000 is started. This routine is repeatedly executed, for example, every 100 ms. In this routine, the CPU 610 calculates the amount of flow of hydrogen that is supplied to the fuel cell stack 100 (final fuel flow amount Qf_fin) by correcting the hydrogen flow amount (basic fuel flow amount Qf_bse) commensurate with the load demand i_req on the basis of the oxygen concentration fluctuation value σo that shows the fluctuation of the oxygen concentration o in the combustion exhaust gas that is discharged from the combustion portion 200.

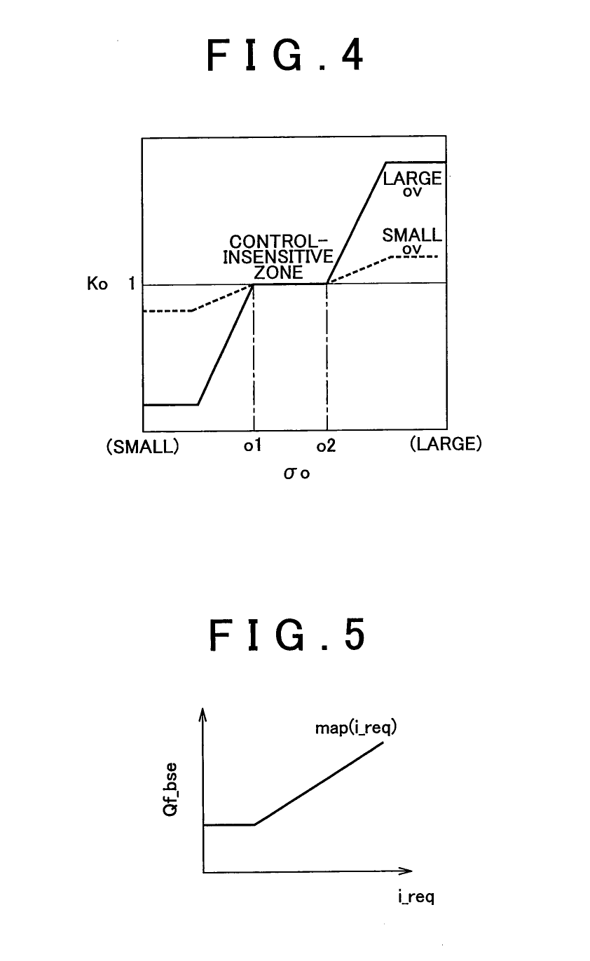

FIG. 4 is a diagram showing a relation between the oxygen concentration fluctuation value σo and a correction coefficient Ko in this embodiment. The correction coefficient Ko is a coefficient for correcting the amount of flow of hydrogen supplied to the fuel cell stack 100 so that the fluctuation of the oxygen concentration o in the combustion exhaust gas is within an appropriate range. As shown in FIG. 4, the correction coefficient Ko=1.0 if the oxygen concentration fluctuation value σo is any value between a first value o1 and a second value o2. That is, the amount of flow of hydrogen supplied to the fuel cell stack 100 (basic fuel flow amount Qf_bse) is not corrected. In this embodiment, the first value of and the second value o2 are determined beforehand by experiments.

In the embodiment, the map 622 representing the relation between the oxygen concentration fluctuation value σo and the correction coefficient Ko shown in FIG. 4 is stored beforehand in the memory 620. The correction coefficient Ko is derived by using the graph-of a solid line in FIG. 4 if an average oxygen concentration ov is larger than a predetermined value, and is derived by using the graph of an interrupted line if the average oxygen concentration ov is smaller than a predetermined value.

In the case where the oxygen concentration o detected by the oxygen concentration sensor 204 is small, the measurement accuracy of the fluctuation (amplitude) of the oxygen concentration o declines. Therefore, in the case where the average oxygen concentration ov is small, if the amount of flow of hydrogen supplied to the fuel cell stack 100 is increased or decreased in the same manner as in the case where the average oxygen concentration ov is large, there is possibility of malfunction of the fuel cell system 1000. In this embodiment, in order to restrain the malfunction associated with the correction of the amount of flow of hydrogen supplied to the fuel cell stack 100, the map 622 is created so that the value of the correction coefficient Ko is smaller in the case where the average oxygen concentration ov is small than in the case where the average oxygen concentration ov is large. Incidentally, in this embodiment, it is defined that “the average oxygen concentration ov is large” in the case where the average oxygen concentration ov is larger than or equal to 10%, and “the average oxygen concentration ov is small” in the case where the average oxygen concentration ov is less than 10%.

In the map 622 shown in FIG. 4, the value of the correction coefficient Ko is set large in the case where the oxygen concentration fluctuation value σo is larger than the second value o2, and the value of the correction coefficient Ko is set small in the case where the oxygen concentration fluctuation value σo is smaller than the first value o1.

That is, in the case where the oxygen concentration fluctuation value go is larger than the second value o2, the amount of flow of hydrogen supplied to the fuel cell stack 100 is made larger than the basic fuel flow amount Qf_bse that is commensurate with the load demand i_req. In the case where the oxygen concentration fluctuation value CYO is large, it is considered that an electricity generation failure has occurred in the fuel cell stack 100 (e.g., there is a unit cell that is not able to generate electricity due to fuel shortage, or the like), and therefore it is considered that the electricity generation of the fuel cell stack 100 will become stable if the amount of flow of hydrogen supplied to the fuel cell stack 100 is increased.

On the other hand, in the case where the oxygen concentration fluctuation value σo is smaller than the first value o1, the amount of flow of hydrogen supplied to the fuel cell stack 100 is made less than the basic, fuel flow amount Qf_bse that is commensurate with the load demand i_req. In the case where the oxygen concentration fluctuation value σo is small, it is considered that the state of electricity generation of the fuel cell stack 100 is good (stable) and excess amount of fuel (hydrogen) is being supplied to the fuel cell stack 100. Therefore, it is considered that the electricity generation efficiency of the fuel cell stack 100 will be improved by decreasing the amount of flow of hydrogen supplied to the fuel cell stack 100.

FIG. 5 is a diagram showing a relation between the basic fuel flow amount Qf_bse and the load demand i_req that is input to the CPU 610 via the input/output port 630. The basic fuel flow amount Qf_bse shown in FIG. 5 is the amount of flow of hydrogen that is needed in order to obtain an output that meets the load demand i_req in the case where the state of the fuel cell stack 100 (the reaction temperature, the degree of degradation, etc.) is an ideal state. In this embodiment, the amount of flow of hydrogen supplied to the fuel cell stack 100 (final fuel flow amount Qf_fin) is determined by correcting the basic fuel flow amount Qf_bse shown in FIG. 5 in accordance with the state of operation of the fuel cell stack 100. In this embodiment, the map 623 representing the relation between the load demand i_req and the basic fuel flow amount Qf_bse shown in FIG. 5 is stored beforehand in the memory 620.

As shown in. FIG. 3, when the routine is started as the fuel cell system 1000 is started, the CPU 610 determines whether or not a sensor warm-up completion flag recorded in the memory 620 is on (step S130). If the sensor warm-up completion flag is off (NO in step S130), the CPU 610 ends the routine.

If the sensor warm-up completion flag is on (YES in step S130), the CPU 610 stores into the memory 620 the oxygen concentration o in the combustion exhaust gas from the combustion portion 200 which is detected by the oxygen concentration sensor 204, and counts up to n=n+1 (step S132). Then, the CPU 610 determines whether or not the number n of detection samples of the oxygen concentration is larger than or equal to the maximum number n_trg of detection samples of the oxygen concentration (step S134). In this embodiment, the maximum number n_trg of detection samples of the oxygen concentration is 250 (n_trg=250). If the number n of detection samples of the oxygen concentration is less than n_trg (No in step S134), this routine ends.

That is, the values of the oxygen concentration o in the combustion exhaust gas detected by the oxygen concentration sensor 204 are accumulated in the memory 620 until the number of samples of the oxygen concentration in the combustion exhaust gas reaches 250.

If the number n of detection samples of the oxygen concentration is larger than or equal to n_trg (YES in step S134), the CPU 610 calculates the oxygen concentration fluctuation value σo and the average oxygen concentration ov (step S136).

The oxygen concentration fluctuation value σo is calculated using the following expression (1).

σ o={square root over ((nΣ[o]²−(Σ[o])²)/n(n−1))} (1)

After that, the CPU 610 clears the earliest measured oxygen concentration o, thereby changing the number n of detection samples of the oxygen concentration to n−1 (step S138). For example, until n=250, the process of step S132 is performed every 100 ms, and the values of the oxygen concentration detected by the oxygen concentration sensor 204 are accumulated with regard to n=0 to 249. When n=250 is reached and the oxygen concentration fluctuation value σo and the average oxygen concentration ov are calculated with regard to n=0 to 249, the value of the oxygen concentration corresponding to n=0 is cleared from the memory 620, so that n=249 results.

The CPU 610 derives a correction coefficient Ko by using the oxygen concentration fluctuation value σo and the average oxygen concentration ov that are calculated in step S136 with reference to the map 622 (step S140).

The CPU 610 derives the basic fuel flow amount Qf_bse commensurate with the input load demand i_req is derived with reference to the map 623 (step S144). Finally, the CPU 610 calculates the final fuel flow amount Qf_fin on the basis of the correction coefficient Ko derived in step S140 and the basic fuel flow amount Qf derived in step S144 (step S146), and then ends this routine.

The CPU 610 controls the flow-regulating valve 106 so as to achieve the final fuel flow amount Qf_fin that is calculated as described above.

For example, if the combustion in the combustion portion 200 is not good (e.g., misfire occurs in a portion of the combustion portion 200), it is considered that the fluctuation of the oxygen concentration o in the combustion exhaust gas will increase. On the other hand, if electricity generation failure occurs in the fuel cell stack 100, the temperature of the fuel cell stack 100 declines. Consequently, it is considered that the temperature of the combustion portion 200 that burns the exhaust gas discharged from the fuel cell stack 100 will decline and therefore the combustion failure of the combustion portion 200 will occur. That is, in the case where electricity generation failure has occurred in the fuel cell stack 100, it is considered that the fluctuation of the oxygen concentration o in the combustion exhaust gas increases.

In the fuel cell system 1000 of this embodiment, the final fuel flow amount Qf_fin is calculated by correcting the hydrogen flow amount commensurate with the load demand i_req (i.e., the basic fuel flow amount Qf_bse) through the use of the correction coefficient Ko on the basis of the fluctuation of the oxygen concentration o in the combustion exhaust gas discharged from the combustion portion 200 (i.e., the oxygen concentration fluctuation value σo). The correction coefficient Ko is a coefficient for correcting the amount of hydrogen supplied to the fuel cell stack 100 so that the fluctuation of the oxygen concentration o in the combustion exhaust gas occurs within an appropriate range. In the fuel cell system 1000, the fluctuation of the oxygen concentration o in the combustion exhaust gas is within an appropriate range since the amount of flow of hydrogen supplied to the fuel cell stack 100 is controlled so as to achieve the post-correction final fuel flow amount Qf_fin. That is, the stability of electricity generation and the electricity generation efficiency of the fuel cell stack 100 are improved. According to the fuel cell system 1000 of this embodiment, the fuel flow amount (hydrogen flow amount) can be properly controlled so as to achieve both the stability of electricity generation and the electricity generation efficiency of the fuel cell stack 100.

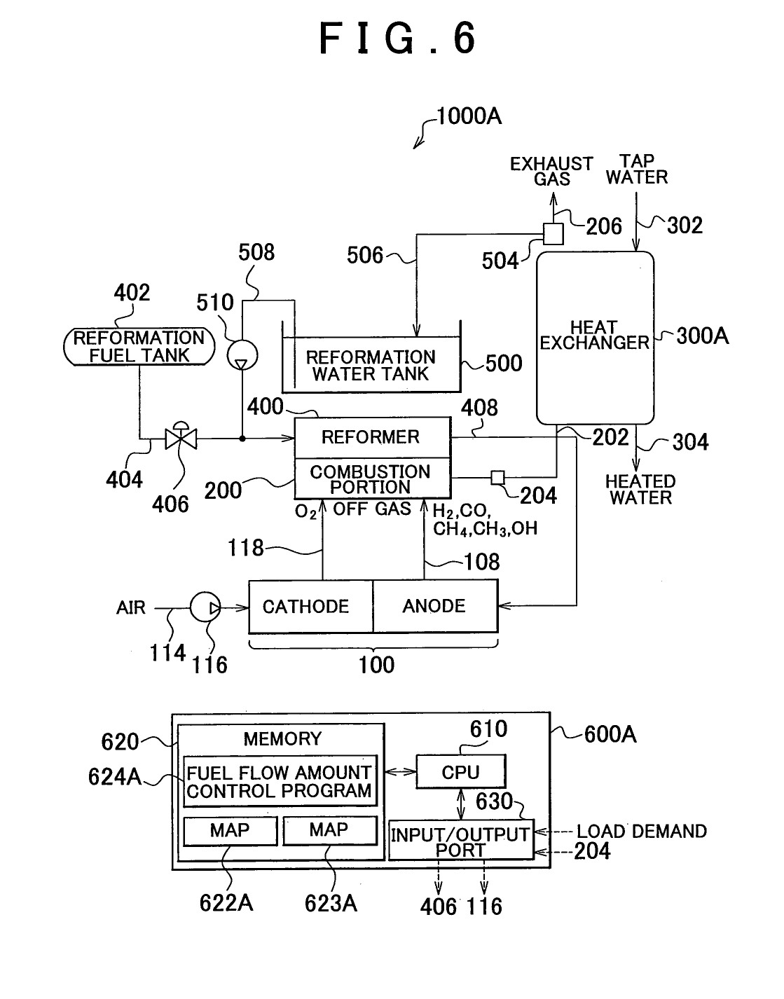

FIG. 6 is an illustrative diagram schematically showing a construction of a fuel cell system 1000A as a second embodiment of the invention. The fuel cell system 1000A of this embodiment is different from the fuel cell system 1000 of the first embodiment mainly in that the fuel cell system 1000A is equipped with a reformer 400, and in that in the control of the fuel flow amount, changes in the output of the oxygen concentration sensor in a fixed oxygen concentration atmosphere are taken into account.

In FIG. 6, substantially the same constructions as those in the fuel cell system 1000 of the first embodiment are represented by the same reference characters, and the descriptions thereof are omitted below.

In the fuel cell system 1000A of this embodiment, the anode exhaust gas discharged from a fuel cell stack 100 is burned in the combustion portion 200 through the use of the cathode exhaust gas that is also discharged from the fuel cell stack 100. Utilizing heat produced in the combustion portion 200, a fuel gas containing hydrogen is produced in the reformer 400, and then the gas is supplied to the fuel cell stack 100. Besides, utilizing heat of the combustion exhaust gas discharged from the combustion portion 200, tap water is heated via a heat exchanger 300, and the heated water is supplied to a user.

The reformer 400 includes a mixing portion (not shown) and a reformation portion (not shown). A reformation fuel supplied from a reformation fuel tank 402 (described below) and water supplied from a reformation water tank 500 (described below) are mixed and gasified in the mixing portion. Hereinafter, the gas formed by the mixing and gasifying in the mixing portion will be referred to as “mixture gas”. The reformation portion is equipped with a reformation catalyst (not shown) that accelerates the reformation reaction. When the mixture gas produced in the mixing portion is introduced into the reformation portion, the reformation reaction progresses due to the reformation catalyst, producing a fuel gas that contains hydrogen. Since this reformation reaction is an endothermic reaction and therefore requires input of heat, heat generated by the combustion reaction in the combustion portion 200 is utilized for the reformation reaction in this embodiment. The reformation catalyst used is appropriately determined according to the reformation fuel that is used for the reformation reaction. Incidentally, the fuel gas that is produced in the reformer 400 and supplied to the fuel cell stack 100 contains carbon monoxide (CO), carbon dioxide (CO₂), methane (CH₄), and unreacted reformation fuel, besides hydrogen.

A reformation fuel supply system that supplies methanol as a reformation fuel to the reformer 400 includes a reformation fuel tank 402, a reformation fuel supply passageway 404, and a flow-regulating valve 406 provided in the reformation fuel supply passageway 404. The reformation fuel tank 402 stores methanol as a reformation fuel. Incidentally, the reformation fuel used in this embodiment is not limited to methanol, but may also be hydrocarbon (gasoline, kerosene, natural gas, etc.), alcohol or the like, (ethanol, methanol, etc.), aldehyde, ammonia, etc.

The methanol stored in the reformation fuel tank 402 is supplied to the reformer 400 via the reformation fuel supply passageway 404 while the amount of flow thereof is adjusted to a predetermined amount by the flow-regulating valve 406. The flow-regulating valve 406 is controlled on the basis of the fluctuation (oscillation amplitude) of the oxygen concentration in the combustion exhaust gas discharged from the combustion portion 200 as described below.

The fuel gas produced in the reformer 400 which contains hydrogen, carbon monoxide, carbon dioxide, methane and unreacted reformation fuel (methanol) is supplied to the anodes of the fuel cell stack 100 via the supply passageway 408.

A combustion exhaust gas passageway 202, an exhaust gas release passageway 206, a tap water introduction passageway 302 and a heated water release passageway 304 are connected to a heat exchanger 300A. In this embodiment, the heat exchanger 300A heats tap water using heat of the combustion exhaust gas discharged from the combustion portion 200. That is, the combustion exhaust gas introduced into the heat exchanger 300A via the combustion exhaust gas passageway 202 is deprived of heat by the tap water within the heat exchanger 300A, and turns into a low-temperature combustion exhaust gas, which is released into the atmosphere via the exhaust gas release passageway 206.

A reformation water supply system for supplying the reformer 400 with water to be used for the reformation reaction (hereinafter, referred to also as “reformation water” includes a condenser 504, a condensed water passageway 506, the reformation water tank 500, a reformation water supply passageway 508 and a reformation water pump 510. The condenser 504 is provided on the exhaust gas release passageway 206, and condenses water vapor that is contained in the combustion exhaust gas that is cooled in the heat exchanger 300A. The condensed water passageway 506 is connected to the condenser 504. Via the condensed water passageway 506, the liquid water condensed in the condenser 504 (hereinafter, referred to also as “condensed water”) is stored into the reformation water tank 500. The condensed water (reformation water) stored in the reformation water tank 500 is introduced into the reformation fuel supply passageway 404 via the reformation water supply passageway 508 by the reformation water pump 510. In this manner, both methanol as a reformation fuel and reformation water are supplied to the reformer 400.

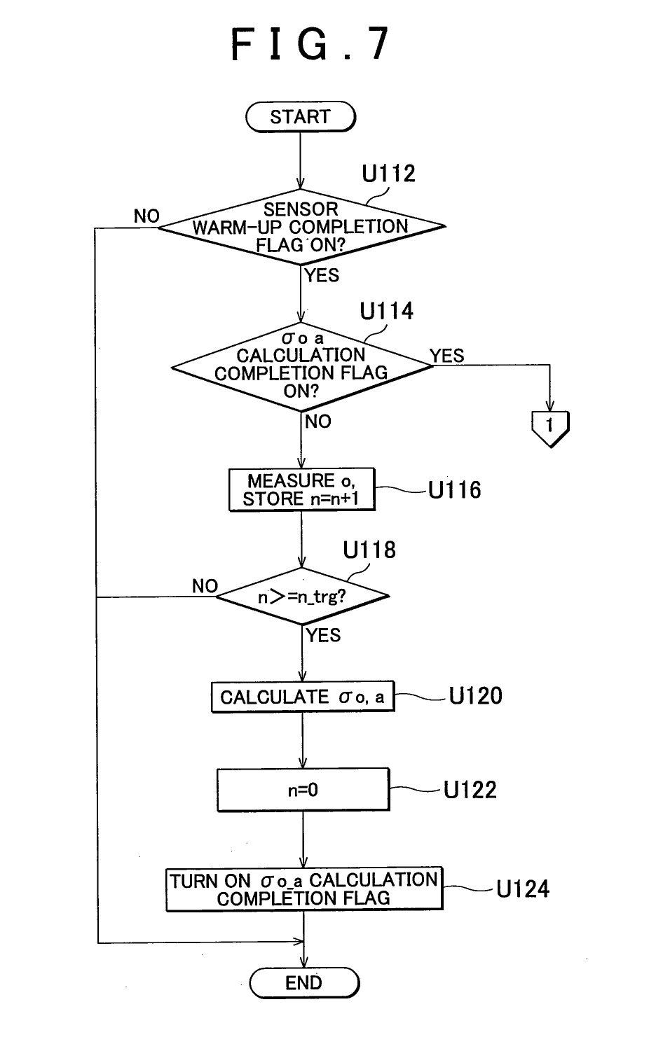

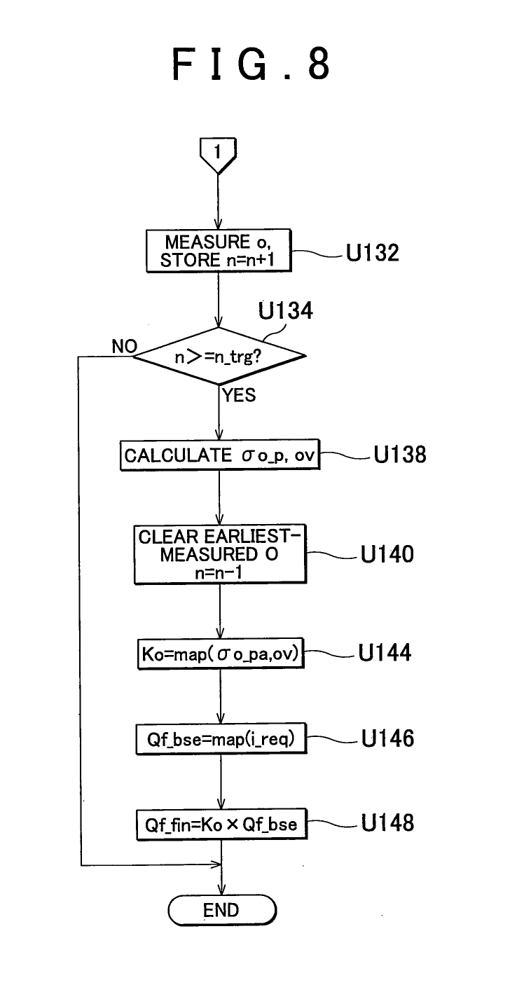

A control portion 600A in the second embodiment is different from the control portion 600-in the first embodiment mainly in a fuel flow control program 624A, a map 622A and a map 623A that are stored in a memory 620. The fuel flow control program 624A includes the sensor warm-up detection routine (FIG. 2) described above in conjunction with the first embodiment, and also includes a fuel flow calculation routine (FIG. 7 and FIG. 8) (described below). Since the sensor warm-up detection routine in this embodiment is the same as in the first embodiment, the description thereof is omitted below.

In the fuel cell system 1000A of this embodiment, the fuel gas containing water which is produced in the reformer 400 is supplied to the fuel cell stack 100, unlike the first embodiment. Therefore, the control portion 600 calculates an appropriate amount of flow of the fuel gas supplied to the fuel cell stack 100 (final fuel flow amount Qf_fin) on the basis of the fluctuation of the oxygen concentration detected by the oxygen concentration sensor 204, and controls the flow-regulating valve 406 so that the calculated final fuel flow amount Qf_fin of the fuel gas is produced in the reformer 400. As a result, the amount of flow of the fuel gas supplied to the fuel cell stack 100 (hereinafter, referred to also as “fuel flow amount”) is controlled on the basis of the fluctuation of the oxygen concentration detected by the oxygen concentration sensor 204.

FIGS. 7 and 8 show a flowchart that represents a fuel flow calculation routine that is executed by the CPU 610 of the control portion 600A that is provided in the fuel cell system 1000A. This routine is executed when the fuel cell system 1000A is started. The routine is repeatedly executed, for example, every 100 ms. In this routine, the fuel flow amount supplied to the fuel cell stack 100 (final fuel flow amount Qf_fin) is calculated by correcting the fuel flow amount (basic fuel flow amount Qf_bse) commensurate with the load demand i_req on the basis of the in-exhaust oxygen concentration fluctuation value σo_p that shows the fluctuation of the oxygen concentration o in the combustion exhaust gas discharged from the combustion portion 200.

The fuel flow calculation routine in this embodiment is different from the routine in the first embodiment in that the oxygen concentration o_a in the air is taken into account to derive:the correction coefficient Ko. Hereinafter, the value of fluctuation of the oxygen concentration in the combustion exhaust gas which has been corrected by taking into account an in-air oxygen concentration fluctuation value σo_a that shows the fluctuation of the oxygen concentration o_a in the air is referred to as “corrected oxygen concentration fluctuation value σo_pa”. The corrected oxygen concentration fluctuation value σo_pa is equal to the in-exhaust oxygen concentration fluctuation value σo_p in the combustion exhaust gas minus the in-air oxygen concentration fluctuation value σo_a in the air.

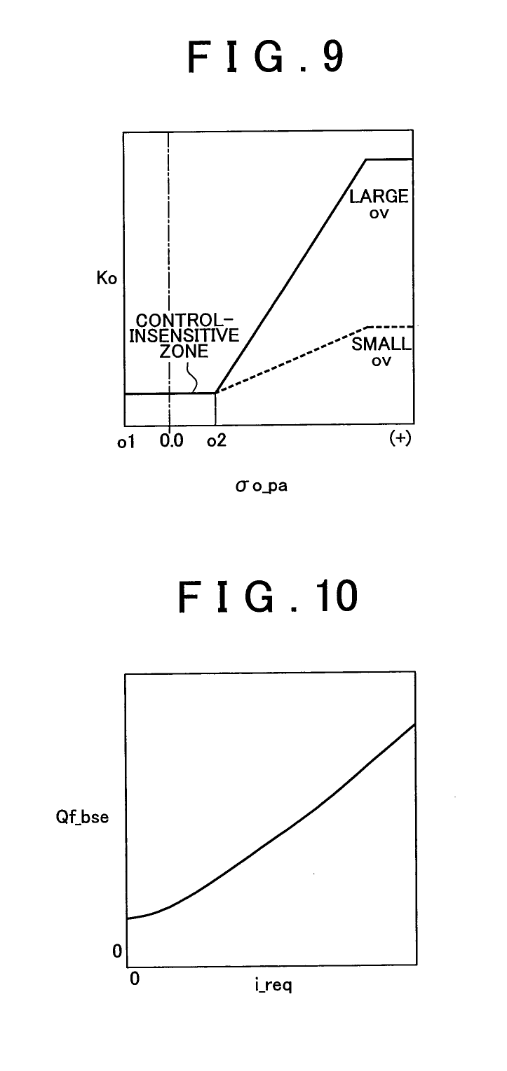

FIG. 9 is a diagram showing a relation between the corrected oxygen concentration fluctuation value σo_pa and the correction coefficient Ko in this embodiment. The correction coefficient Ko is a coefficient for correcting the amount of flow of hydrogen supplied to the fuel cell stack 100 so that the corrected oxygen concentration fluctuation value σo_pa is within an appropriate range. In this embodiment, the map 622A that represents the relation between the corrected oxygen concentration fluctuation value σo_pa and the correction coefficient Ko shown in FIG. 9 is stored beforehand in the memory 620. In the same manner as in the first embodiment, the correction coefficient Ko is derived by using the graph of a solid line in FIG. 9 in the case where the average oxygen concentration ov is larger than a predetermined value, and is derived by using the graph of an interrupted line in FIG. 9 in the case where the average oxygen concentration ov is smaller than a predetermined value.

FIG. 10 is a diagram showing a relation between the basic fuel flow amount Qf_bse and the load demand i_req that is input to the CPU 610 via the input/output port 630. In this embodiment, the map 623A that represents the relation between the load demand i_req and the basic fuel flow amount Qf_bse shown in FIG. 10 is stored beforehand in the memory 620.

As shown in FIG. 7, when this routine is started as the fuel cell system 1000A is started, the CPU 610 determines whether or not a sensor warm-up completion flag recorded in the memory 620 is on (step U112). If the sensor warm-up completion flag is off (NO in step U112), the CPU 610 ends this routine.

If the sensor warm-up completion flag is on (YES in step U112), the CPU 610 determines whether or not a σo-a calculation completion flag recorded in the memory 620 is on (step U114). The σo-a calculation completion flag is off when the fuel cell system 1000A is started. If in step U114 it is determined that the σo-a calculation completion flag is off, the CPU 610 stores into the memory 620 the oxygen concentration o in the gas flowing in the combustion exhaust gas passageway. 202 which is detected by the oxygen concentration sensor 204, and counts up as in n=n+1 (step U116).

In the fuel cell system 1000A in this embodiment, hydrogen is not supplied to the fuel cell stack 100 and an apparatus-scavenging air is supplied until the σo-a calculation completion flag becomes on. As a result, air passes in the combustion exhaust gas passageway 202, and therefore the oxygen concentration sensor 204 detects the oxygen concentration in the air. Then, the CPU 610 determines whether or not the number n of detection samples of the oxygen concentration is larger than or equal to the maximum number n_trg of detection samples of the oxygen concentration (step U118). In this embodiment, the maximum number n_trg of detection samples of the oxygen concentration is equal to 250 as in the first embodiment. If the number n of detection samples of the oxygen concentration is less than n_trg (NO in step U118), the CPU 610 ends the routine.

That is, the values of the oxygen concentration o in the air detected by the oxygen concentration sensor 204 are accumulated in the memory 620 until the number of samples of the oxygen concentration reaches 250.

If the number n of detection samples of the oxygen concentration is larger than or equal to n_trg (YES in step U118), the CPU 610 calculates the in-air oxygen concentration fluctuation value σo_a (step U120).

The in-air oxygen concentration fluctuation value σo_a is calculated in substantially the same manner as in the calculation of the oxygen concentration fluctuation value σo in the combustion exhaust gas in the first embodiment through the use of the foregoing expression (1).

After that, the CPU 610 sets n=0 (step U122); and turns on the σo-a calculation completion flag stored in the memory 620 (step U124), and then ends the routine. In this manner, the in-air oxygen concentration fluctuation value σo_a is calculated.

In the embodiment, when the σo-a calculation completion flag is turned on, hydrogen is supplied to the fuel cell stack 100, so that the operation of the fuel cell starts.

If in step U114 it is determined that the in-air Oxygen concentration fluctuation value σo_a is on, the CPU 610 proceeds to step U132 (FIG. 8). In step U132, the CPU 610 stores into the memory 620 the oxygen concentration o in the combustion exhaust gas discharged from the combustion portion 200 which is detected by the oxygen concentration sensor 204, and counts as in n=n+1 (step U132). Then, the CPU 610 determines whether or not the number n of detection samples of the oxygen concentration is larger than or equal to the maximum number n_trg of detection samples of the oxygen concentration (step U134). In this embodiment, the maximum number n_trg of detection samples of the oxygen concentration is equal to 250. If the number n of detection samples of the oxygen concentration is less than n_trg (NO in step U134), the CPU 610 ends this routine.

That is, the values of the oxygen concentration o in the combustion exhaust gas detected by the oxygen concentration sensor 204 are stored into the memory 620 until the number of samples of the oxygen concentration o in the combustion exhaust gas reaches 250.

If the number n of detection samples of the oxygen concentration is larger than or equal to n_trg (YES in step U134), the CPU 610 calculates the in-exhaust oxygen concentration fluctuation value σo-p and the average oxygen concentration ov in the combustion exhaust gas are calculated (step U138). The in-exhaust oxygen concentration fluctuation value no-p is calculated through the use of the foregoing expression (1).

After that, the CPU 610 clears the earliest measured oxygen concentration 0, thereby changing the number n of detection samples of the oxygen concentration to n−1 (step U140). The CPU 610 calculates the corrected oxygen concentration fluctuation value σo_pa by using the in-exhaust oxygen concentration fluctuation value σo-p calculated in step U138 and the in-air oxygen concentration fluctuation value σo-a calculated in step U120. Then, the CPU 610 derives the correction coefficient Ko by using the corrected oxygen concentration fluctuation value σo_pa and the average oxygen concentration ov with reference to the map 622A (step U144).

The CPU 610 derives the basic fuel flow amount Qf_bse commensurate with the input load demand i_req with reference to the map 623A (step U146). Finally, the CPU 610 calculates the final fuel flow amount Qf_fin on the basis of the correction coefficient Ko derived in step U144 and the basic fuel flow amount Qf_bse derived in step U146 (step U148), and then ends the routine.

The CPU 610 controls the amount of flow of the reformation fuel supplied from the reformation fuel tank 402 to the reformer 400 by adjusting the flow-regulating valve 406 so that the amount of flow of the fuel gas supplied to the fuel cell stack 100 becomes equal to the final fuel flow amount Qf_fin calculated as described above.

As described above, the fuel cell system 1000A in this embodiment derives the correction coefficient Ko on the basis of the corrected oxygen concentration fluctuation value σo_pa (a value obtained by subtracting the in-air oxygen concentration fluctuation value σo_a from the in-exhaust oxygen concentration fluctuation value σo-p). That is, since the time-dependent change of the oxygen concentration sensor 204 is taken into account, the fuel flow amount supplied to the fuel cell stack 100 can be appropriately controlled despite the time-dependent change of the oxygen concentration sensor 204.

Besides, as described above, the fuel cell system 1000A in this embodiment is equipped with the reformer 400, and the fuel gas produced by the reformer 400 is supplied to the fuel cell stack 100. The fuel gas, containing hydrogen, further contains carbon monoxide, carbon dioxide, methane and unreacted reformation fuel (methanol), and carbon monoxide, methane and methanol as well as hydrogen are used and consumed in the electricity generation by the fuel cell stack 100. Then, hydrogen, carbon monoxide, methane and methanol that are not consumed in the fuel cell stack 100 are supplied to the combustion portion 200, and are burned therein.

The combustion range of carbon monoxide, methane and methanol is narrower than the combustion range of hydrogen. Therefore, the possibility of occurrence of combustion failure in the combustion portion 200 is larger than in the first embodiment. Since the reformation reaction in the reformer 400 is an endothermic reaction as mentioned above, there is possibility that if combustion failure occurs in the combustion portion 200, reformation reaction failure may occur and therefore may degrade the electricity generation performance (stable electricity generation, and electricity generation efficiency). That is, the state of combustion (combustion failure) in the combustion portion 200 has a great effect on the electricity generation performance (stability of electricity generation and electricity generation efficiency), compared with the case where the fuel gas supplied to the fuel cell stack 100 is only hydrogen as in the first embodiment.

Therefore, if the amount of flow of the reformation fuel supplied to the reformer 400 is controlled on the basis of the value of fluctuation of the oxygen concentration in the combustion exhaust gas as in the fuel cell system 1000A of this embodiment, the stability of electricity generation and the electricity generation efficiency are improved. That is, the application of the invention to a fuel cell system that uses a gas supplied from a reformer as in the second embodiment will achieve more remarkable effects than the application of the invention to a fuel cell system in which pure hydrogen is supplied as in the first embodiment.

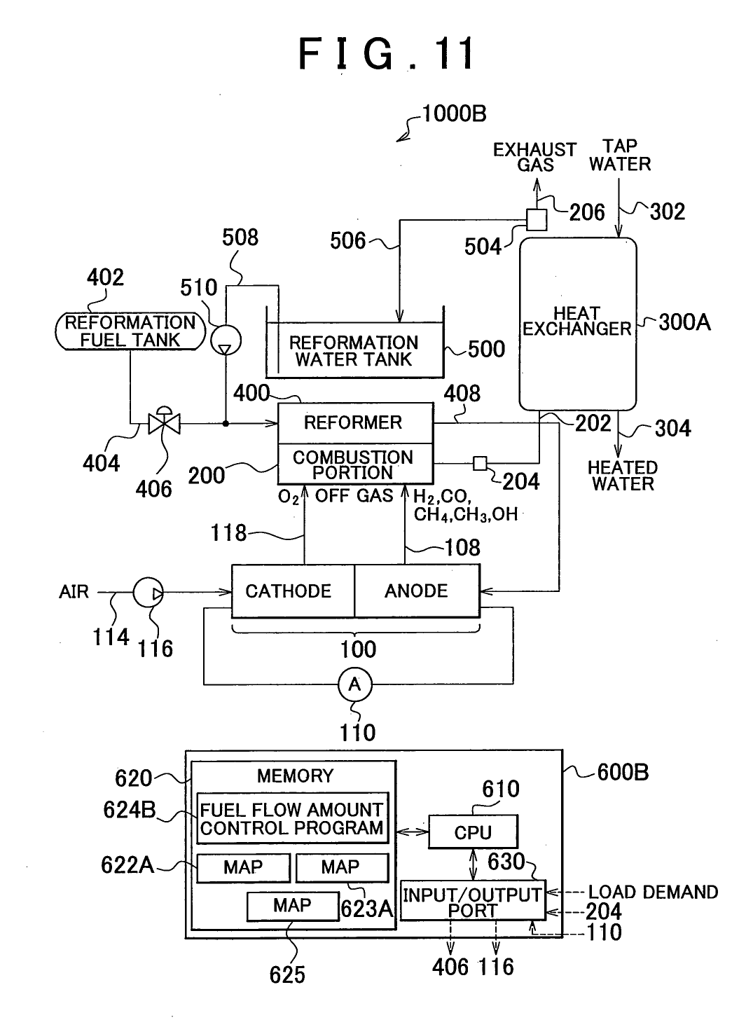

FIG. 11 is an illustrative diagram schematically showing a construction of a fuel cell system 1000B as a third embodiment of the invention. The fuel cell system 1000B of this embodiment is different from the fuel cell system 1000A of the second embodiment mainly in that the fuel cell system 1000B is equipped with an ammeter 110 that measures the output current of a fuel cell stack 100, and that the output current of the fuel cell stack 100 is taken- into account in the control of the fuel flow amount. In FIG. 11, substantially the same constructions as those in the fuel cell system 1000A of the second embodiment are represented by the same reference characters, and the descriptions thereof are omitted below.

In this embodiment, the amount of methanol supplied from a reformation fuel tank 402 that stores methanol to a reformer 400 is controlled on the basis of the value of fluctuation of the oxygen concentration in the combustion exhaust gas discharged from the combustion portion 200 and the output current of the fuel cell stack 100 as described below. In consequence, the fuel flow amount supplied to the fuel cell stack 100 is controlled as in the second embodiment.

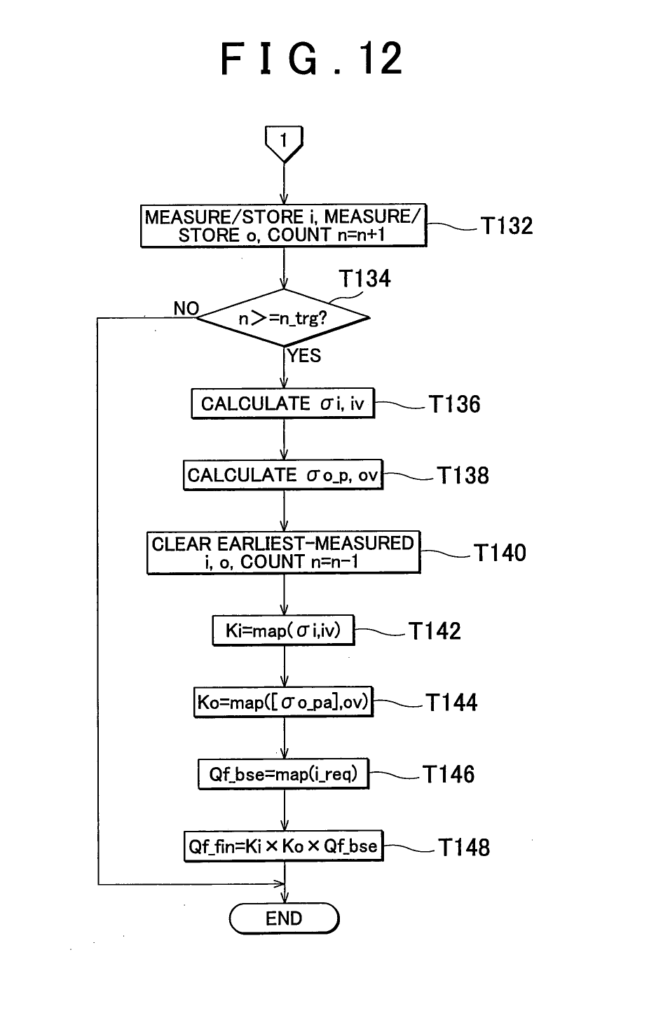

FIG. 12 is a flowchart representing a portion of a fuel flow calculation routine that is executed by a CPU 610 of a control portion 600B that is provided in the fuel cell system 1000B. This routine is provided by substituting the process shown in FIG. 8 in the fuel flow calculation routine (shown in FIGS. 7 and 8) in the second embodiment with a process shown in FIG. 12. Therefore, the earlier portion of the routine of this embodiment (i.e., the process shown in FIG. 7) is omitted from the drawings and from the description below. The fuel flow calculation routine of the third embodiment is different from the routine of the second embodiment in that the fluctuation of the output current i of the fuel cell stack 100 is taken into account in calculating the hydrogen flow amount (final fuel flow amount Qf_fin). Hereinafter, the fluctuation of the output current i of the fuel cell stack 100 will be referred to as “output current fluctuation value σi”.

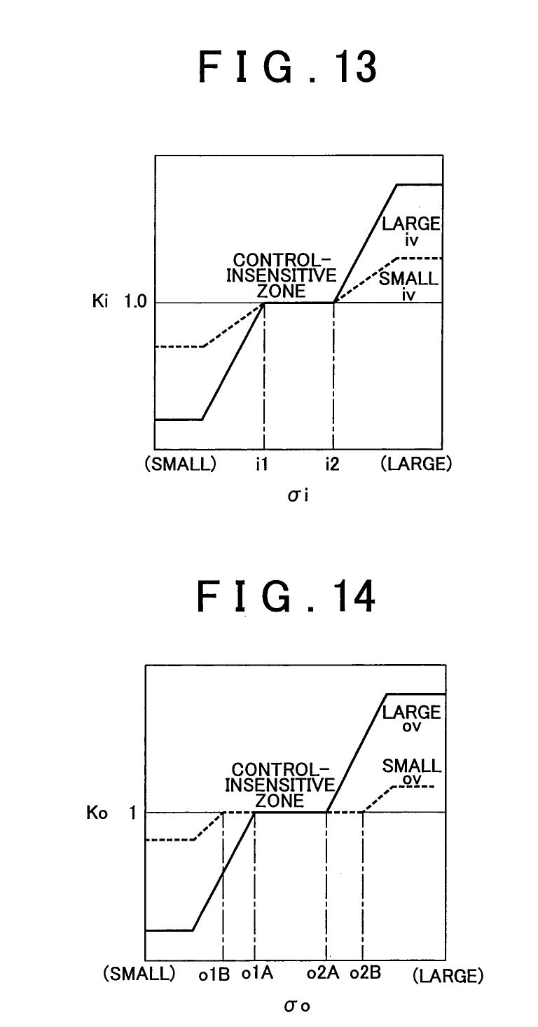

FIG. 13 is a diagram showing a relation between the output current fluctuation value σi and a correction coefficient Ki in this embodiment. The correction coefficient Ki is a coefficient for correcting the amount of flow of hydrogen supplied to the fuel cell stack 100 so that the output current fluctuation value σi is in an appropriate range.

As shown in FIG. 13, the correction coefficient Ki=1.0 when the output current fluctuation value ai is a value between a third value i1 and a fourth value i2. That is, the amount of the fuel gas supplied to the fuel cell stack 100 (the basic fuel flow amount Qf_bse). is not corrected. In this embodiment, the third value i1 and the fourth value i2 are determined beforehand by experiments.

In this embodiment, a map 625 representing the relation between the output current fluctuation value σi and the correction coefficient Ki shown in FIG. 13 is stored beforehand in a memory 620. The correction coefficient Ki is derived by using the graph of a solid line in FIG. 13 if the average output current iv is larger than a predetermined value, and is derived by using the graph of an interrupted line if the average output current iv is smaller than a predetermined value.

If the output current i detected by the ammeter 110 is small, the measurement accuracy of the fluctuation (amplitude) of the output current i declines. Therefore, in the case where the average output current iv is small, if the amount of flow of hydrogen supplied to the fuel cell stack 100 is increased or decreased in the same manner as in the case where the average output current iv is large, there is possibility of malfunction of the fuel cell stack 100. In this embodiment, in order to restrain the malfunction associated with the correction of the hydrogen flow amount supplied to the fuel cell stack 100, the map 625 is created so that in the case where the average output current iv is small, the value of the correction coefficient Ki is smaller than in the case where the average output current iv is large. Incidentally, in the embodiment, for example, it is defined that “the average output current iv is large” if the average output current iv is larger than or equal to 10 A, and that “the average output current iv is small” if the average output current iv is less than 10 A.

In the map 625 shown in FIG. 13, the value of the correction coefficient Ki is made relatively large in the case where the output current fluctuation value σi is larger than the fourth value i2, and is made relatively small in the case where the output current fluctuation value σi is smaller than the third value i1.

That is, in the case where the output current fluctuation value σi is larger than the fourth value i2, the amount of flow of the fuel gas supplied to the fuel cell stack 100 is made larger than the basic fuel flow amount Qf_bse that is commensurate with the load demand i_req. In the case where the output current fluctuation value σi is large, it is considered that electricity generation failure has occurred in the fuel cell stack 100 (e.g., there is a unit cell that is not able to generate electricity due to fuel shortage, or the like), and therefore it is considered that the electricity generation of the fuel cell stack 100 will become stable if the amount of flow of the fuel gas supplied to the fuel cell stack 100 is increased.

On the other hand, in the case where the output current fluctuation value σi is smaller than the third value i1, the amount of flow of the fuel gas supplied to the fuel cell stack 100 is made less than the basic fuel flow amount Qf_bse that is commensurate with the load demand i_req. In the case where the output current fluctuation value of is small, it is considered that the state of electricity generation of the fuel cell stack 100 is good (stable) and excess amount of fuel (hydrogen) is being supplied to the fuel cell stack 100. Therefore, it is considered that the electricity generation efficiency of the fuel cell stack 100 will be improved by decreasing the amount of flow of hydrogen supplied to the fuel cell stack 100.

In this embodiment, the maps 622A and 623A shown in FIGS. 9 and 10 are also pre-stored in the memory 620 as in the second embodiment.

This routine is executed when the fuel cell system 1000B is started, and is repeatedly executed, for example, every 100 ms. When the routine is started as the fuel cell system 1000B is started, the CPU 610 executes steps U112 to U124 in the FIG. 7.

If determining in step U114 that the σo-a calculation completion flag is on, the CPU 610 proceeds to step T132 (FIG. 12). In step T132, the CPU 610 detects the output current i of the fuel cell stack 100 by the ammeter 110, and detects the oxygen concentration o in the combustion exhaust gas from the combustion portion 200 by the oxygen concentration sensor 204. Then, the CPU 61 stores these detection results in the memory 620, and counts up as in n=n+1 (step T132). After that, the CPU 610 determines whether or not the number n of detection samples of the oxygen concentration is larger than or equal to the maximum number n_trg of detection samples of the oxygen concentration (step T134).

In this embodiment, the maximum number n_trg of detection samples of the oxygen concentration is equal to 250. If the number n of detection samples of the oxygen concentration is less than n_trg (NO in step T134), the CPU 610 ends this routine. In this embodiment, the detection of the output current i is carried out simultaneously with the detection of the oxygen concentration o, and therefore the number n of detection samples of the oxygen concentration is equal to the number of detection samples of the electric current.

That is, until the number n of samples of the oxygen concentration o in the combustion exhaust gas reaches 250, the values of the output current i detected by the ammeter 110 and the values of the oxygen concentration o in the combustion exhaust gas detected by the oxygen concentration sensor 204 are stored into the memory 620.

If the number n of detection samples of the oxygen concentration is larger than or equal to n_trg (YES in step T134), the CPU 610 calculates the output current fluctuation value of and the average output current iv (step T138). Then, the CPU 610 calculates the in-exhaust oxygen concentration fluctuation value σo-p and the average oxygen concentration ov in the combustion exhaust gas (step T138).

The in-exhaust oxygen concentration fluctuation value σo-p is calculated using the foregoing expression (1). The output current fluctuation value σi is calculated using the following expression (2):

σ i={square root over ((nΣ[i]²−(Σ[]²)/n(n−1))} (2)

After that, the CPU 610 clears the earliest measured output current i and the earliest measured oxygen concentration o, thereby changing the number n of detection samples of the oxygen concentration to n−1 (step T140). The CPU 610 derives the correction coefficient Ki by using the output current fluctuation value and the average output current iv that are calculated in step T136, with reference to the map 625 shown in FIG. 13 (step T142). Subsequently, the CPU 610 calculates the corrected oxygen concentration fluctuation value σo_pa by using the in-exhaust oxygen concentration fluctuation value σo-p calculated in step T138 and the in-air- oxygen concentration fluctuation value σo_a calculated in step T120, as in the second embodiment. Then, the CPU 610 derives the correction coefficient Ko by using the corrected oxygen concentration fluctuation value σo_pa and the average oxygen concentration ov with reference to the map 622A shown in FIG. 9 (step T144).

The CPU 610 derives the basic fuel flow amount Qf_bse commensurate with the input load demand i_req, with reference to the map 623A shown in FIG. 10 (step T146). Finally, the CPU 610 calculates the final fuel flow amount Qf_fin on the basis of the correction coefficient Ki derived in step T142, the correction coefficient. Ko derived in step T144, and the basic fuel flow amount Qf_bse derived in step T146 (step T148).

The CPU 610 controls the amount of flow of the reformation fuel supplied from the reformation fuel tank 402 to the reformer 400 by regulating the flow-regulating valve 406 so that the amount of hydrogen supplied to the fuel cell stack 100 becomes equal to the final fuel flow amount Qf_fin that is calculated as described above.

For example, if electricity generation failure occurs in a portion of the fuel cell stack 100, the fluctuation of the output current i is considered to become large. The correction coefficient Ki in this embodiment is a coefficient for correcting the amount of flow of hydrogen supplied to the fuel cell stack 100 so that the fluctuation of the output current i is within an appropriate range.

In the fuel cell system 1000B in this embodiment, the final fuel flow amount Qf_fin is calculated by correcting the fuel flow amount (basic fuel flow amount Qf_bse) commensurate with the load demand i_req so that the oxygen concentration in the combustion exhaust gas, the output current of the fuel cell stack 100, and their respective fluctuation values are within predetermined ranges. Therefore, in the fuel cell system 1000B equipped with the reformer 400, the stability of electricity generation and the electricity generation efficiency are further improved.

Incidentally, this invention is not limited to foregoing embodiments or examples, but may also be carried out, for example, with the following modifications.

In the map 622 in the foregoing first embodiment, the range of the oxygen concentration fluctuation value σo in which Ko=1.0 (i.e., the range from the first value of to the second value o2) is the same between the case where the average oxygen concentration ov is large and the case where the average oxygen concentration ov is small. However, the range of the oxygen concentration fluctuation value σo in which Ko=1.0 may be different between the case where the average oxygen concentration ov is large and the case where the average oxygen concentration ov is small. For example, FIG. 14 is a diagram showing a relation between the oxygen concentration fluctuation value σo and the correction coefficient. Ko according to a modification. In FIG. 14, in the case where the average oxygen concentration ov is small, the range of the oxygen concentration fluctuation value σo in which Ko=1.0 is set broader than in the case where the average oxygen concentration ov is large. In the case where the oxygen concentration o detected by the oxygen concentration sensor 204 is small, the measurement accuracy of the fluctuation (amplitude) of the oxygen concentration o declines. By setting the proper range of the oxygen concentration fluctuation value σo (i.e., the range of the oxygen concentration fluctuation value σo in which Ko=1.0) to a relatively broad range, the possibility of occurrence of a malfunction of the fuel cell system 1000 can be reduced.

Likewise, the range of the output current fluctuation value σi in which Ki=1.0 (the range from the third value i1 to the fourth value i2) may also be different between the case where the average output current iv is large and the case where the average output current iv is small. The same applies to the case where the control is performed using the output voltage.

Although in the foregoing embodiments, the proportion of increase/decrease of the fuel flow amount is changed according to whether the average oxygen concentration ov is large or small and whether the average output current iv is large or small, the proportion of increase/decrease of the fuel flow amount may be fixed regardless of whether the average oxygen concentration ov is large or small, or whether the average output current iv is large or small. Besides, the criteria of whether the average oxygen concentration ov is large or small and whether the average output current iv is large or small are limited to what are shown above in conjunction with the embodiments.

Although the system that turns tap water into heated water by utilizing heat generated by the combustion portion 200 and the system that generates hydrogen via the reformer 400 by using heat generated by the combustion portion 200 are shown as the foregoing embodiments, the invention is not limited to the foregoing embodiments, but is applicable to various fuel cell systems that are equipped with a fuel cell and a combustion portion.

Although in the foregoing embodiments, SOFC is used as the fuel cell stack 100, it is also possible to use various fuel cells, for example, a solid polymer electrolyte fuel cell, a hydrogen separation membrane-type fuel cell, etc.

The relation between the correction coefficient Ko and the oxygen concentration fluctuation value σo, and the relation between the correction coefficient Ki and the output current fluctuation value σi are not limited to the relations shown in diagrams in conjunction with the forgoing embodiments. For example, although, in FIG. 4, which shows the first embodiment, the correction coefficient Ko linearly increases in the case where the oxygen concentration fluctuation value σo is larger than the second value o2, the correction coefficient Ko may increase along a curved line, and may also increase and decrease. It suffices that the relation between the correction coefficient Ko and the oxygen concentration fluctuation value σo is such a relation that the oxygen concentration fluctuation value σo is brought between the first value o1 and the second value o2 when corrected by correcting the basic fuel flow amount Qf_bse with the correction coefficient Ko. Besides, it also suffices that the relation between the correction coefficient Ki and the output current fluctuation value ai is such a relation that the output current fluctuation value is brought between the third value i1 and the fourth value i2 by correcting the basic fuel flow amount Qf_bse with the correction coefficient Ki.

In the third embodiment, the example in which the fuel flow amount is controlled on the basis of the in-exhaust oxygen concentration fluctuation value σo-p and the output current fluctuation value ai of the fuel cell stack is described. However, it is also permissible to adopt a construction in which a voltmeter is provided instead of the ammeter 110, and the fuel flow amount is controlled on the basis of the in-exhaust oxygen concentration fluctuation value σo-p and the fluctuation value of the output voltage of the fuel cell stack. Besides, it is also permissible to adopt a construction that includes both the ammeter 110 and a voltmeter.

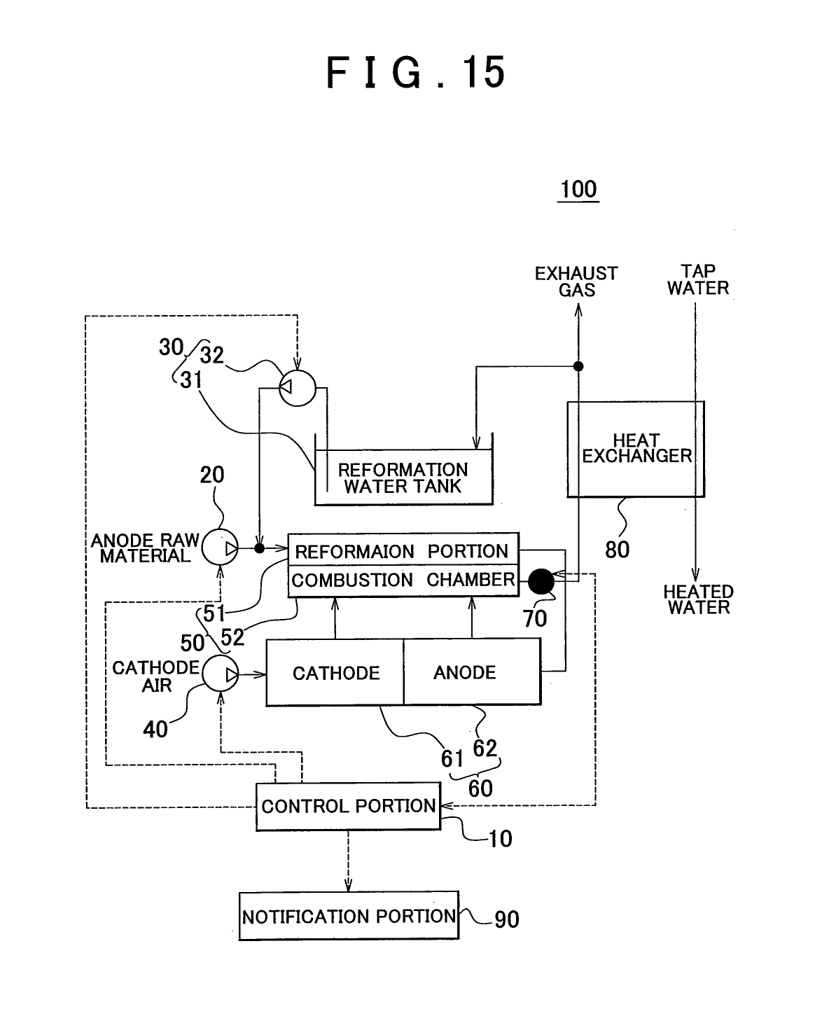

The fuel cell according to the first to third embodiments degrades with declines in the reformation efficiency of the reformer. If a hydrocarbon sensor is provided for detecting decline in the reformation efficiency of the reformer, an increased cost results. A fourth embodiment of the invention relates to a fuel cell system that omits the cost for a hydrocarbon sensor. FIG. 15 is a schematic diagram showing an overall construction of a fuel cell system 2000 in accordance with the fourth embodiment. As shown in FIG. 15, a fuel cell system 2000 includes a control portion 10, an anode raw-material supply portion 20, a reformation water supply portion 30, a cathode air supply portion 40, a reformer 50, a fuel cell 60, an oxygen sensor 70, a heat exchanger 80, and a notification device 90.

The anode raw-material supply portion 20 includes a fuel pump for supplying a fuel gas, such as hydrocarbon or the like, to a reformation portion 51, and the like. The reformation water supply portion 30 includes a reformation water tank 31 that stores reformation water that is needed for reformation reaction in the reformation portion 51, a reformation water pump 32 for supplying reformation water stored in a reformation water tank 31 to a reformation portion 51, etc. The cathode air supply portion 40 includes an air pump for supplying an oxidant gas, such as air or the like, to a cathode 61.

The reformer 50 includes the reformation portion 51 and a combustion portion 52. The fuel cell 60 has a structure in which an electrolyte is sandwiched between a cathode 61 and an anode 62. An example of the fuel cell 60 that is usable herein is a solid oxide type fuel cell (SOFC). The notification device 90 is a device, for giving caution, alarm, etc. to a user or the like. The control portion 10 is made up of a CPU (central processing unit), a ROM (read-only memory), a RAM (random-access memory), etc.

Subsequently, an overview of the operation of the fuel cell system 2000 will be described. The anode raw-material supply portion 20 supplies a necessary amount of fuel gas to the reformation portion 51 in accordance with a command from the control portion 10. The reformation water pump 32 supplies a necessary amount of reformation water to the reformation portion 51 in accordance with a command from the control portion 10. The reformation portion 51 produces a reformed gas that contains hydrogen, from the fuel gas and the reformation water through the reformation reaction that utilizes heat that is generated in the combustion portion 52. The thus-produced reformed gas is supplied to the anode 62.

The cathode air supply portion 40 supplies a necessary amount of cathode air to the cathode 61 in accordance with a command from the control portion 10. Therefore, electricity is generated in the fuel cell 60. The cathode off-gas discharged from the cathode 61 and the anode off-gas discharged from the anode 62 flow into the combustion portion 52. In the combustion portion 52, a combustible component in the anode off-gas burns due to oxygen in the cathode off-gas. Heat obtained through the combustion is given to the reformation portion 51 and the fuel cell 60.

Thus, in the fuel cell system 2000, combustible components, such as hydrogen, carbon monoxide, etc., which are contained in the anode off-gas can be burned in the combustion portion 52. The oxygen sensor 70 detects the oxygen concentration in the exhaust gas discharged from the combustion portion 52, and gives a result of the detection to the control portion 10. The heat exchanger 80 exchanges heat between tap water and the exhaust gas discharged from the combustion portion 52. The condensed water obtained from the exhaust gas through the heat exchange is stored in the reformation water tank 31. The notification device 90 gives a user or the like information about the state of the fuel cell 60.

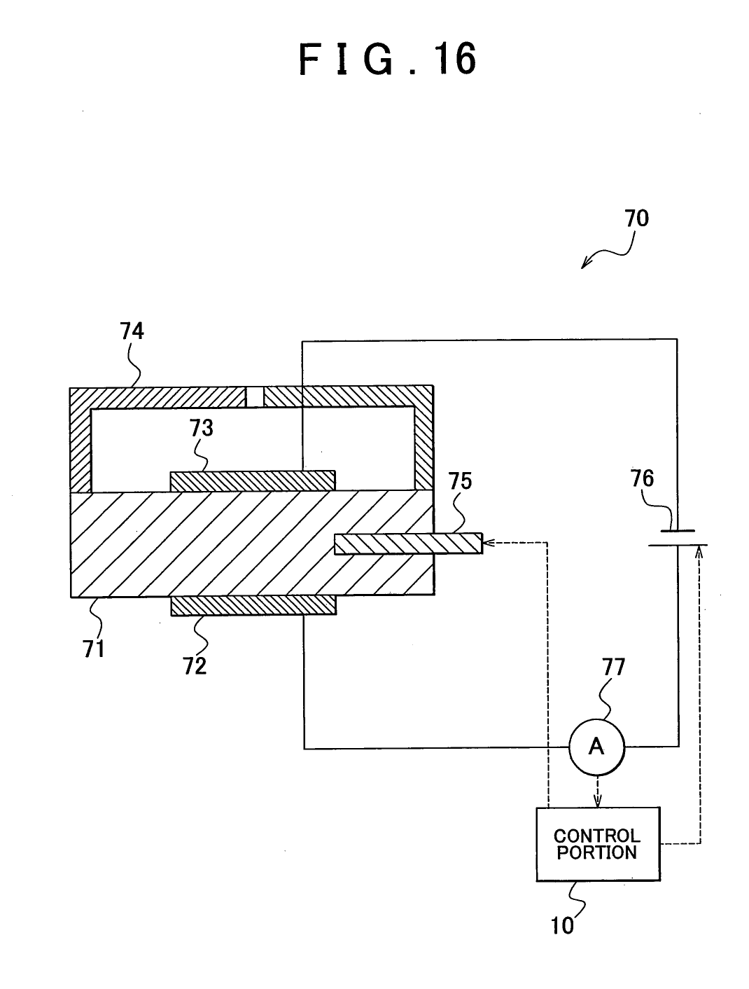

FIG. 16 is a schematic sectional view for describing details of the oxygen sensor 70. As shown in FIG. 16, the oxygen sensor 70 is a limiting-current oxygen sensor, and has a structure in which an anode 72 is provided on a surface of an electrolyte 71, and a cathode 73 is provided on another surface of the electrolyte 71, and a porous base board 74 having small pores is disposed so as to cover the cathode 73. A heat 75 is disposed in the electrolyte 71.

The electrolyte 71 is made of an oxygen-ion conductive electrolyte, for example, zirconia. The anode 72 and the cathode 73 are made of, for example, platinum. The anode 72 and the cathode 73 form an external circuit via wiring. This circuit is provided with an electric power source 76 and an ammeter 77. The porous base board 74 is made of, for example, porous alumina. The heat 75 is made of, for example, a platinum thin film or the like.

Subsequently, the control of the oxygen sensor 70 by the control portion 10 will be described. The control portion 10 heats the electrolyte 71 by supplying electric power to the heater 75. After the temperature of the electrolyte 71 reaches a predetermined value, the control portion 10 controls the electric power source 76 so that plus voltage is applied to the anode 72. When voltage is applied to the anode 72 by the electric power source 76, oxygen turns into oxygen ions on the cathode 73 as in the following expression (3), and oxygen ions are conducted in the electrolyte 71. On the anode 72, oxygen ions turn into oxygen molecules as in the following expression (4).

O₂+4e⁻→2O²⁻ (3)

2O²⁻→O₂+4e⁻ (4)

The amount of oxygen transported to the cathode 73 is governed by the size of the pores of the porous base board 74. Therefore, the electric current (limiting current) that is caused by the reactions shown in expression (3) and expression (4) is determined by the amount of oxygen gas diffused in the pores of the porous base board 74. The amount of oxygen gas diffused is determined by the oxygen concentration outside the porous base board 74.

The control portion 10 acquires an output current of the oxygen sensor 70 according to the detection value from the ammeter 77. The output current of the oxygen sensor 70 is proportional to the oxygen concentration. On the basis of the proportional relation, the control portion 10_{—} detects the oxygen concentration in the atmosphere to which the oxygen sensor 70 is exposed.

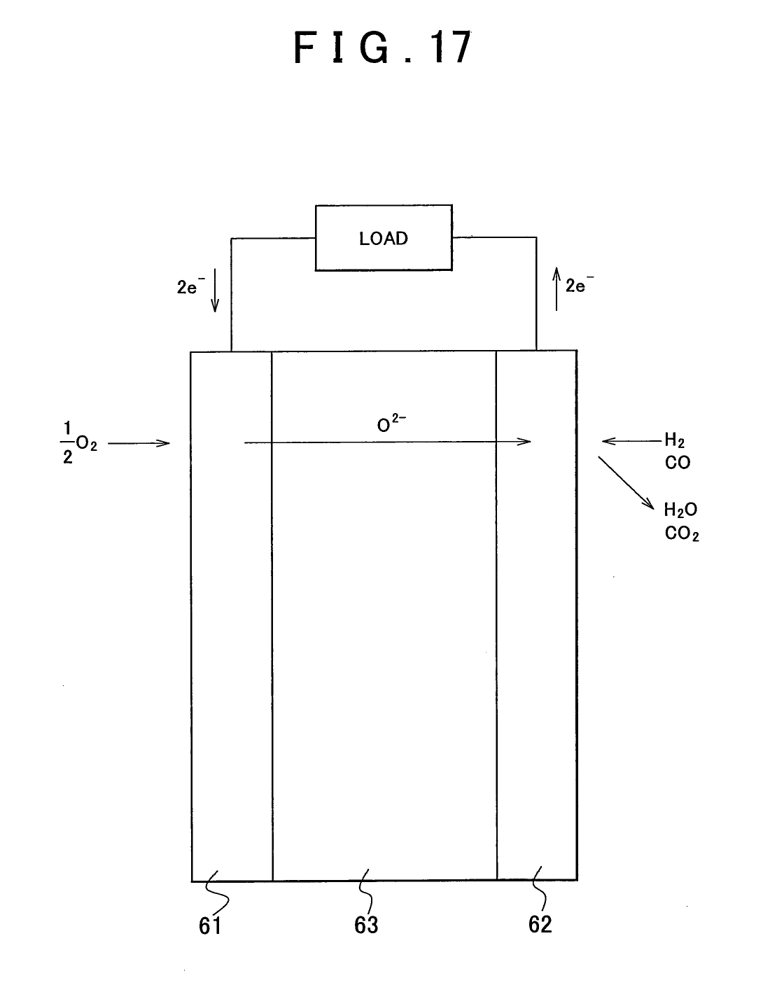

FIG. 17 is a schematic diagram for describing details of the fuel cell 60. As shown in FIG. 17, the fuel cell 60 has a structure in which an electrolyte 63 is sandwiched between a cathode 61 and an anode 62. A material of the cathode 61 is, for example, lanthanum manganite or the like. A material of the anode 62 is, for example, nickel or the like. A material of the electrolyte 63 is, for example, zirconia or the like.

Hydrogen and carbon monoxide in the reformed gas supplied to the anode 62 release electrons to the anode 62. The electrons released to the anode 62 are supplied to the cathode 61 after moving through an external circuit and performing an electrical work. Oxygen in the cathode air supplied to the cathode 61 turns into oxygen ions by receiving, electrons supplied to the cathode 61. The oxygen ions move through the electrolyte 63 and reach the anode 62. On the anode 62, the hydrogen that has released electrons and the oxygen ions react to produce water and carbon dioxide gas.

If the reformation efficiency of the reformer 50 declines due to declines of the function of a catalyst, the concentration of a hydrocarbon fuel in the reformed gas supplied from the reformer 50 to the anode 62 becomes high. In this case, the hydrocarbon fuel reacts with water vapor in a water vapor reformation reaction shown in the following expression (5), with the nickel of the anode 62 serving as a catalyst. As a result, hydrogen and carbon monoxide are produced. Incidentally, in expression (3), methane is used as an example of the hydrocarbon fuel. The hydrogen and the carbon monoxide produced as in the expression (3) are used in the foregoing electricity generating reaction.

CH₄+H₂O→CO+3H₂ (5)

However, in the case where hydrocarbon fuel is supplied to the anode 62, carbon in the hydrocarbon fuel may sometimes deposit on a surface of the anode 62. The catalyst function of the anode 62 declines as the deposition of carbon progresses. In consequence, the electricity generation performance of the fuel cell 60 declines, and the hydrocarbon concentration in the anode off-gas increases. Therefore, it is possible to determine that the fuel cell 60 has degraded due to detection of an increase in the hydrocarbon concentration in the anode off-gas. Incidentally, the catalyst function of the anode 62 also declines due to oxidation of the anode 62 as well.

For example, if the catalyst function of the anode 62 declines, the ratio between the hydrogen concentration and the hydrocarbon concentration in the anode off-gas changes. Since the specific burnups of hydrocarbon and hydrogen are different from each other, the state of combustion of the combustion portion 52 changes with changes in the ratio between the hydrogen concentration and the hydrocarbon concentration. Therefore, in this embodiment, an increase in the hydrocarbon concentration in the anode off-gas is detected on the basis of the change of the state of combustion of the combustion portion 52.

Concretely, since the specific burnup of hydrocarbon is lower than the specific burnup of hydrogen, the specific burnup of the anode off-gas declines if the hydrocarbon concentration relative to hydrogen in the anode off-gas increases. Therefore, the combustion in the combustion portion 52 becomes unstable, and the oxygen concentration in exhaust gas fluctuates. On the other hand, if the hydrocarbon concentration relative to the hydrogen concentration in the anode off-gas decreases, the specific burnup of the anode off-gas improves. Therefore, the combustion in the combustion portion 52 becomes stable, and the changing of the oxygen concentration in the exhaust gas is restrained. Thus, it can be determined whether or not the hydrocarbon concentration in the anode off-gas has increased on the basis of a result of the detection by the oxygen sensor 70.

Furthermore, since the combustion-limit mixture ratio of hydrocarbon (e.g., about 2.5 in the case of methane) is larger than the combustion-limit mixture ratio of hydrogen (e.g., 10), the amount of fluctuation of the state of combustion can be enlarged by increasing the air excess rate λ of the combustion portion 52. Therefore, by increasing the air excess rate λ, the accuracy in detecting the state of combustion is improved. Incidentally, the air excess rate λ can be controlled by controlling the amount of an anode raw material supplied from the anode raw-material supply portion 20 and the amount of cathode air supplied from the cathode air supply portion 40.

In this embodiment, if it is determined that the fuel cell 60 has degraded, the notification device 90 gives a warning or the like to the user according to a command from the control portion 10. Therefore, the user or the like can carry out the checking of the fuel cell 60, or the like. A concrete control for detecting the state of the fuel cell 60 will be described below.

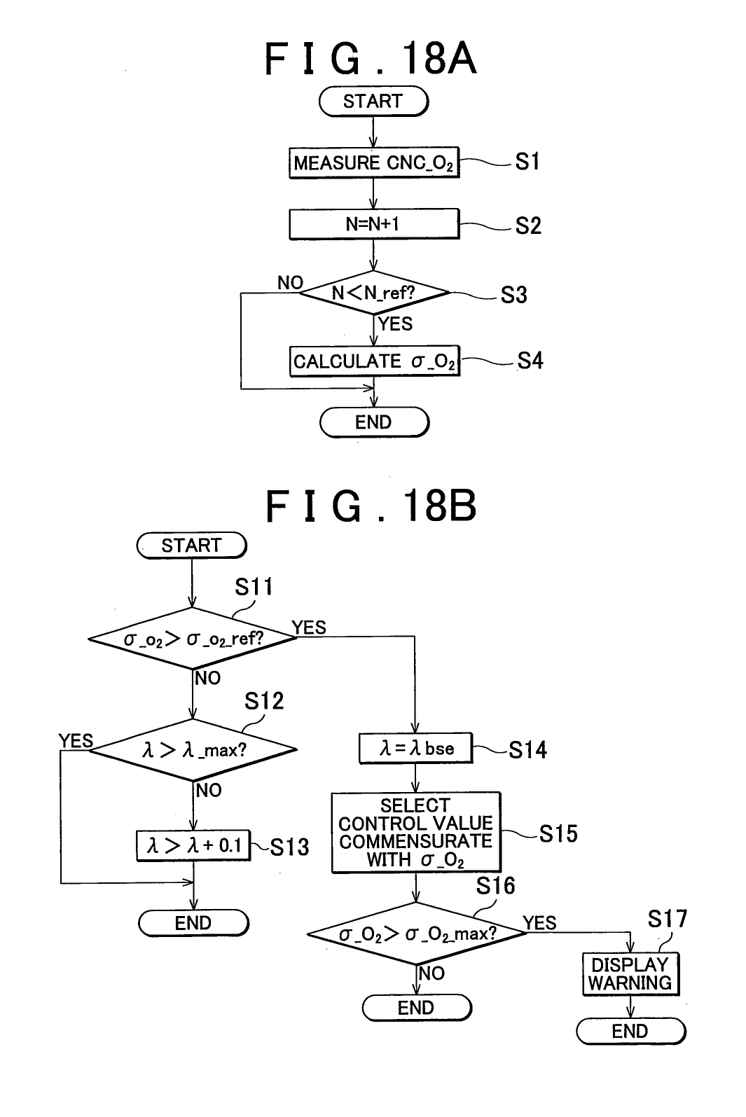

FIG. 18A is a flowchart showing an example of a flow of process that is executed in order to acquire oxygen concentration fluctuation. The flow of process shown in FIG. 18A is executed periodically (e.g., every 100 ms). As shown in FIG. 18A, the control portion 10 measures the oxygen concentration CNC_O₂ in the exhaust gas from the combustion portion 52, on the basis of a result of the detection performed by the oxygen sensor 70 (step S1). Next, the control portion 10 adds “1” to a counter value N (step S2).

Next, the control portion 10 determines whether or not the counter value N is less than the number of calculated data N_ref (e.g., “120”) (step S3). If it is determined in step S3 that the counter value N is less than the number of calculated data N_ref, the control portion 10 ends the execution of the flow of process. Thus, the oxygen concentration CNC_O₂ is measured “N_ref” number of times. If in step S3 it is not determined that the counter value N is less than the number of calculated data N_ref, the control portion 10 calculates an oxygen concentration fluctuation a O₂ from the “N_ref” number of oxygen concentrations CNC_O₂ (step S4). Incidentally, the oxygen concentration fluctuation a O₂ is a standard deviation that is calculated from the “N_ref” number of oxygen concentrations CNC_O₂.

FIG. 18B is a flowchart showing an example of a flow of process that the control portion executes when determining the presence/absence of degradation of the fuel cell 60 through the use of the oxygen concentration fluctuation σ_O₂ stored as shown in the flowchart of FIG. 18A. As shown in FIG. 18B, the control portion 10 determines whether or not the oxygen concentration fluctuation σ_O₂ is larger than a permissible upper limit σ_O₂_{_{—}}ref (e.g., “0.2”) (step S11). The permissible upper limit σ_O₂_{_{—}}ref is a threshold value for determining the fluctuation of the state of combustion in the combustion portion 52.

If in step S11 it is not determined that the oxygen concentration fluctuation σ_O₂ is larger than the permissible upper limit σ_O₂_{_{—}}ref, the control portion 10 determines whether or not the air excess rate λ is larger than an upper-limit excess rate λ_max (e.g., “8”) (step S12). Herein, the upper-limit excess rate λ_max is a maximum value of the air excess rate that is permitted in the combustion portion 52.

If in step S12 it is determined that the air excess rate λ is larger than the upper-limit excess rate λ_max, the control portion 10 ends the execution of the flow of process show in FIG. 18B. If in step S12 it is not determined that the air excess rate λ is larger than the upper-limit excess rate λ_max, the control portion 10 increases the air excess rate λ by “0.1” (step S13). As the process of step S13 is repeated, the air excess rate λ is gradually increased. Therefore, the accuracy in detecting the oxygen concentration fluctuation σ_O₂ improves.

If in step S11 it is determined that the oxygen concentration fluctuation σ_O₂ is larger than the permissible upper limit σ_O₂_{_{—}}ref, the control portion 10 controls the air excess rate λ to an ordinary control value λ_bse (e.g., “2.5”) (step S14). The ordinary control value λ_bse is an air excess rate that is maintained through control during ordinary electricity generation of the, fuel cell 60.

Next, the control portion 10 selects a control value commensurate with the oxygen concentration fluctuation σ_O₂ (step S15). For example, the control portion 10 performs a control for stabilizing combustion in the combustion portion 52. Concretely, the control portion 10 performs a control of increasing the amount of anode raw-material supplied from the anode raw-material supply portion 20.

Next, the control portion 10 determines whether or not the oxygen concentration fluctuation σ_O₂ is larger than the warning criterion value σ_{—}_l O₂_{_{—}}max (e.g., “0.5”) (step S16). The warning criterion value σ_O_{2—}max is a threshold value for determining whether or not the fuel cell 60 has degraded. If in step S16 it is determined that the oxygen concentration fluctuation σ_O₂ is larger than the warning criterion value σ_O₂_{_{—}}max, the control portion 10 controls the notification device 90 so- as to display a warning (step S16). After that, the control portion 10 ends the execution of the flow of process shown in FIG. 18B. Besides, if step S16 it is not determined that the oxygen concentration fluctuation σ_O₂ is larger than the warning criterion value σ_O₂_{_{—}}max, the control portion 10 ends the execution of the flow of process.

According to the FIGS. 18A and 18B, it is possible to detect combustion fluctuations in the combustion portion 52 through the use of the oxygen sensor 70. Therefore, degradation of the fuel cell 60 can be detected.

Incidentally, in the case where the air excess rate λ is gradually increased, it can be determined that degradation of the fuel cell 60 has progressed to a degree that is larger the larger the oxygen concentration fluctuation σ_O₂ relative to the increase in the air excess rate λ. In this case, the degradation of the fuel cell 60 can be quantitatively determined.

In this embodiment, the control portion 10 functions as a determination portion, and the cathode air supply portion 40 functions as air excess rate control means.

Incidentally, the invention can be realized in various forms. For example, the invention may be realized in the forms of a co-generation system that includes a fuel cell system, a control method for a fuel cell system, etc.

While some embodiments of the invention have been illustrated above, it is to be understood that the invention is not limited to details of the illustrated embodiments, but may be embodied with various changes, modifications or improvements, which may occur to those skilled in the art, without departing from the scope of the invention.

1. A fuel cell system comprising:
a fuel cell;
a fuel supply portion that supplies a fuel to the fuel cell;
a combustion portion that burns an anode exhaust gas that is discharged from an anode of the fuel cell;
an oxygen concentration detection portion that detects oxygen concentration; and
a fuel flow control portion that controls amount of flow of the fuel supplied from the fuel supply portion to the fuel cell so that amount of fluctuation of the oxygen concentration in a combustion exhaust gas discharged from the combustion portion which is detected by the oxygen concentration detection portion is between a first value and a second value that is larger than the first value.

2. The fuel cell system according to claim 1, wherein the fuel flow control portion increases the amount of flow of the fuel if the amount of fluctuation of the oxygen concentration in the combustion exhaust gas is larger than the second value, and the fuel flow control portion decreases the amount of flow of the fuel if the amount of fluctuation of the oxygen concentration in the combustion exhaust gas is smaller than the first value.

3. The fuel cell system according to claim 1, wherein:
the fuel supply portion includes a fuel production portion that produces the fuel that is supplied to the fuel cell, by using combustion heat generated by the combustion portion, and a raw-material supply portion that supplies the fuel production portion with a raw material for use for the production of the fuel; and
the fuel flow control portion controls the fuel flow amount supplied to the fuel cell by controlling the amount of flow of the raw material that is supplied to the fuel production portion.

4. The fuel cell system according to claim 1, wherein the first value and the second value are determined based on an amount of fluctuation of the oxygen concentration in air which is detected by the oxygen concentration detection portion.

5. The fuel cell system according to claim 1, wherein, the smaller absolute value of the oxygen concentration in the combustion exhaust gas is, the wider a range defined by the first value and the second value is set.

6. The fuel cell system according to claim 5, wherein, the smaller the absolute value of the oxygen concentration in the combustion exhaust gas is, the more the fuel flow control portion reduces proportion of increase/decrease of the amount of flow of the fuel, when controlling the amount of flow of the fuel so that the amount of fluctuation of the oxygen concentration in the combustion exhaust gas is between the first value and the second value.

7. The fuel cell system according to claim 1, further comprising at least one of an ammeter that measures output current of the fuel cell and a voltmeter that measures output voltage of the fuel cell,
wherein the fuel flow control portion controls the amount of flow of the fuel so that oscillation amplitude of one of the output current measured by the ammeter and the output voltage measured by the voltmeter is between a third value and a fourth value that is larger than the third value.

8. The fuel cell system according to claim 7, wherein the fuel flow control portion increases the amount of flow of the fuel if the oscillation amplitude of one of the output current measured by the ammeter and the output voltage measured by the voltmeter is larger than the fourth value, and the fuel flow control portion decreases the amount of flow of the fuel if the oscillation amplitude of one of the output current measured by the ammeter and the output voltage measured by the voltmeter is smaller than the third value.

9. The fuel cell system according to claim 8, wherein, the smaller the absolute value of the output current is, the wider the range defined by the third value and the fourth value is set.

10. The fuel cell system according to claim 8, wherein the smaller the absolute value of the output current is, the more the fuel flow control portion reduces the proportion of increase/decrease of the amount of flow of the fuel, when controlling the amount of flow of the fuel so that the oscillation amplitude of the output current is between the third value and the fourth value.

11. The fuel cell system according to claim 1, wherein
the amount of fluctuation of the oxygen concentration in the exhaust gas is an oscillation amplitude of the oxygen concentration.

12. The fuel cell system according to claim 1, further comprising:
a reformation portion that produces hydrogen from a hydrocarbon;
a determination portion that determines whether the fuel cell has degraded based on an amount of fluctuation of the oxygen concentration in the exhaust gas from the combustion portion that is the predetermined gas which is detected by the oxygen concentration detection portion; and
wherein the fuel cell generates electricity by using, as a fuel, hydrogen produced by the reformation portion.

13. The fuel cell system according to claim 12, further comprising an air excess rate control portion that controls an air excess rate in the combustion portion,
wherein the air excess rate control portion increases the air excess rate when the determination portion acquires the amount of fluctuation of the oxygen concentration in the exhaust gas.

14. The fuel cell system according to claim 13, wherein, the larger the amount of fluctuation of the oxygen concentration in the exhaust gas relative to increase of the air excess rate in the combustion portion, the larger the determination portion determines that degradation of the fuel cell is.

15. The fuel cell system according to claim 12, further comprising a notification device that notifies a user of degradation of the fuel cell if the determination portion determines that the fuel cell has degraded.

16. The fuel cell system according to claim 12, wherein the amount of fluctuation of the oxygen concentration is a standard deviation that is calculated from a plurality of detection values that are detected by the oxygen sensor during a predetermined period.

17. The fuel cell system according to claim 1, wherein the fuel cell is a solid oxide type fuel cell.

18. The fuel cell system according to claim 1, wherein the anode of the fuel cell contains nickel.

19. A state detection method for a fuel cell which includes a reformation portion that produces hydrogen from a hydrocarbon and a combustion portion that burns an anode off-gas, and which generates electricity by using, as a fuel, the hydrogen produced by the reformation portion, comprising:
detecting oxygen concentration in an exhaust gas from the combustion portion; and
determining presence/absence of a degradation of the fuel cell based on an amount of fluctuation of the oxygen concentration in the exhaust gas detected.

20. The state detection method according to claim 19, wherein determining presence/absence of a degradation of the fuel cell includes increasing air excess rate in the combustion portion in order to acquire the amount of fluctuation of the oxygen concentration in the exhaust gas.

21. The state detection method according to claim 20, wherein:
determining presence/absence of a degradation of the fuel cell includes determining a level of the degradation of the fuel cell; and the larger the amount of fluctuation of the oxygen concentration in the exhaust gas relative to the increase in the air excess rate in the combustion portion is, the larger the determined level is.

22. The state detection method according to claim 19, further comprising notifying a user of the degradation of the fuel cell if it is determined that the fuel cell has degraded.

23. The state detection method according to claim 19, wherein the amount of fluctuation of the oxygen concentration is a standard deviation that is calculated from a plurality of detection values that are detected during a predetermined period.

24. The state detection method according to claim 19, wherein the fuel cell is a solid oxide type fuel cell.

25. The state detection method according to claim 19, wherein an anode of the fuel cell contains nickel.

26. A control method for a fuel cell system that includes a fuel cell and a combustion portion that burns an anode exhaust gas that is discharged from an anode of the fuel cell, comprising:
acquiring an oxygen concentration in a combustion exhaust gas that is discharged from the combustion portion; and
controlling amount of flow of a fuel supplied to the fuel cell so that amount of fluctuation of the oxygen concentration in the combustion exhaust gas acquired is between a first value and a second value that is larger than the first value.

27. The control method according to claim 26, wherein the amount of fluctuation of the oxygen concentration in the exhaust gas is an oscillation amplitude of the oxygen concentration.

28. A fuel cell system comprising:
a reformation portion that produces hydrogen from a hydrocarbon;
a fuel cell that generates electricity by using, as a fuel, hydrogen produced by the reformation portion;
a combustion portion that burns an anode exhaust gas that is discharged from an anode of the fuel cell;
an oxygen concentration detection portion that detects oxygen concentration in the anode exhaust gas; and
a determination portion that determines whether the fuel cell has degraded based on an amount of fluctuation of the oxygen concentration in the exhaust gas from the combustion portion which is detected by the oxygen concentration detection portion.
